(19) United States
(12) Patent Application Publication
(10) Pub. No.: US 2007/0214049 A1
(43) Pub. Date: Sep. 13, 2007

(54) BROADCAST TELEVISION REWARD PROGRAM AND METHOD OF USE FOR ISSUING, AGGREGATING AND REDEEMING SPONSOR'S REWARD POINTS

(76) Inventor: Richard Postrel, Miami Beach, FL (US)

Correspondence Address: Anthony R. Barkume, 20 Gateway Lane, Manorville, NY, 11949, US

(21) Appl. No.: 11/755,340

(22) Filed: May 30, 2007

Related U.S. Application Data
(63) Continuation of application No. 11/539,250, filed on Oct. 6, 2006.
Application No. 11/539,250 is a continuation-in-part of application No. 11/424,407, filed on Jun. 15, 2006.
Application No. 11/424,407 is a continuation-in-part of application No. 10/791,149, filed on Mar. 1, 2004.
Application No. 11/424,407 is a continuation-in-part of application No. 10/809,185, filed on Mar. 25, 2004.
Application No. 11/424,407 is a continuation-in-part of application No. 10/835,550, filed on Apr. 28, 2004.

(51) Int. Cl. G06Q 30/00; H04N 7/10

(52) U.S. Cl. 705/14; 725/32

(57) ABSTRACT

A loyalty program operated in association with a television broadcast network, wherein reward content is provided along with television content (programming and/or advertising) to generate a television broadcast signal that is transmitted to a plurality of viewers. Each viewer may view or hear the reward content via their television receiver (or set top box, personal computer, etc.) along with the associated programming or advertisements, and as a result provide a reward response which may be a visit to a local merchant, a mail-in or call-in response, entered to a web site via the Internet, etc. Reward points, as well as prizes and product discounts may be provided as the reward to the viewer that provides the appropriate reward response. This program can be configured and adapted to provides incentives to viewers to visit certain merchants and sponsors, purchase certain products, view certain programs, and the like, based on the reward parameters employed.

### CROSS-REFERENCE TO RELATED APPLICATIONS

This application is a continuation-in-part application of co-pending U.S. application Ser. No. 11,424,407, filed on Jun. 15, 2006; which is a continuation-in-part application of co-pending application Ser. No. 10/791,149 filed on Mar. 1, 2004; and which is also a continuation-in-part application of co-pending application Ser. No. 10/809,185 filed on Mar. 25, 2004; and which is also a continuation-in-part application of co-pending application Ser. No. 10/835,550 filed on Apr. 28, 2004.

### TECHNICAL FIELD

This invention relates to loyalty or reward points programs, and in particular to a program that implements a reward program and card issued by a broadcast television network and allows affiliated sponsors and merchants to provide reward and incentive points to viewers of television programs on the network, thus managing viewer behavior and leveraging viewer loyalty.

### BACKGROUND ART

Broadcast television networks typically will insert commercials at strategic locations within as well as before and after television shows. Merchants that sponsor the ads continually look for new methods of attracting viewers to buy their products and services. It is extremely difficult for these sponsoring merchants to ascertain the effectiveness of their ads with respect to customer purchases. In other words, merchants cannot usually tell if a customer is making a purchase as a direct result of viewing an ad on television.

In addition, television program recording technologies have evolved to the point where many viewers will time-shift their viewing habits. That is, viewers will record a program and watch it at their leisure, employing controls over the program such as pause, rewind, and fast-forward. Although time shifting has been in practice since VCRs have become available to viewers, the practice has escalated in recent years due to the ease of digital recording and program control techniques popularized by the TIVO products and services. The result of the increased control that users have over their viewing is that many will skip over the commercials by fast forwarding. Some remote control devices has been made available with 30-second skip buttons that conveniently allow the viewer to press the button one or more times to easily skip the commercial. In addition, even if a viewer does not use time shifting techniques, there is no way of knowing if the viewer actually watches a commercial or leaves the viewing area to retrieve snacks or perform other tasks during the several minute commercial time span.

Thus, there is a desire in the art to provide a system that can give an incentive or reward for a viewer to watch a commercial (other than simply making the commercial artistically appealing). There is also a desire in the art to be able to measure the effectiveness of a commercial in terms of its ability to cause a viewer to make a purchase of a product or service of the sponsoring merchant.

In addition to providing an incentive for viewers to watch commercial advertisements, there is a desire by television stations and networks to increase viewership of its programs. That is, television networks continually look for ways to cause viewers to watch more programs on their networks (at the expense of watching shows on competing networks) and to be more loyal to the shows they watch (i.e. watch them regularly). Increased program viewership generally translates to increased commercial advertisement viewership, which will yield increased advertising revenue for the networks.

There is also a desire to provide a system and method for issuing an incentive to viewers, in the form for example of reward points, that may be maintained and tracked for each individual sponsor, yet may be part of a single overall program operated by the television broadcast network. By maintaining individual reward accounts for each sponsor (one of which may the network itself), data may be generated as to the effectiveness of each sponsor's advertisements and the like, and a participating viewer may build value with a particular sponsor by earning reward points from that sponsor. In addition, by providing the implementation under the umbrella of a single program operated by a single broadcast television network, advantages are gained such as increased viewership to the network (since rewards are available only via that network), as well as aggregation and combination of reward points from the different sponsors' programs if desired by a viewer in order to gain more purchasing power.

The use of reward points generally, and on a more basic and simplistic level, has been attempted in the past. That is, in the prior art, in order to attract and retain business customers, airlines, hotels, car rental companies, chain retailers, telecom providers, etc. have historically introduced frequent use programs that offer awards of loyalty or reward points (e.g. frequent flyer miles) or other such incentives schemes based on the distance traveled or purchases made by that customer. Competition has forced airlines to modify the manner in which mileage was acquired to include travel related purchases by consumers. For example, the dollar-based cost of a ticket purchased may be awarded as mileage to a client account. Within the past several years, banks that issue credit cards or other retailers and e-tailers have co-branded credit cards in the name of the airlines and the credit card company where each dollar spent using the card is recorded as a mile of travel or point in the award program. These cards may additionally award bonus miles in coordination with user purchases of preferred products or flights during preferred times.

With regard to FIG. 1, a model of the frequent flyer systems of the prior art is presented. Two different airlines servers are shown surrounded by their related marketing partners. In order to lure more business travelers, the airlines have established marketing agreements with travel related companies to provide the business traveler with a more robust way to generate rewards in the form of frequent flyer miles. These marketing arrangements or associations have typically involved credit card companies, phone companies, hotel chains and car rental companies. Any purchases made through these co-branded partners were then awarded to the user periodically. Bonus miles or points may additionally be accumulated based on the user's actions in response to offers made by the airline or in coordination with the partner company. For example, phone companies purchase reward points or miles and then offer them to their customers based on the customer's agreement to switch to their phone service. These points are obtained by the partner companies by purchasing them from the issuing entity for redistribution as an incentive to utilize their particular goods and/or services. FIG. 2 shows some sample co-branded cards that are representative of marketing agreements between TWA, Sprint, and Mastercard. In order to receive these benefits, the user must sign up with each of the partner companies separately and provide the frequent flyer account number that is to receive the credited reward points or miles. A user either making phone calls or purchases in accordance with the agreements made with each of these partners will first accumulate a value on the partner's system which in turn is periodically updated on the airline's reward server to reflect the value earned during that period. FIG. 3 is representative of a typical user account that shows various earnings in the system transferred in from any of the co-branded partners. The records of the table in FIG. 3 identify the source of the rewards, the dates they were recorded and the number of miles associated with that transaction. The user can view the accumulated miles by accessing the airline's reward server or by tracking the individual value reported to the user through the various bills the user receives from each of the co-branded partners. In any event, the user is faced with an extremely difficult if not practically impossible task of manually coordinating all of his reward accounts to determine how many points may reside in each account, how to redeem points in each account, etc.

Large scale merchants such as chain hotels, chain rental cars, and various airlines are able to implement their own loyalty or reward points schemes since they have the infrastructure in place to maintain user loyalty point accounts. Thus, these large entitles are able to build brand loyalty via their own loyalty reward schemes. They are able to operate independently by awarding their own reward points and redeeming the reward points by offering their own products and services. A typical example is when a user earns 35,000 American Airlines points and trades them in for a free flight or upgrade, or when a user earns Hilton Honors points by staying at a Hilton hotel, and redeems them for free lodging at a Hilton hotel.

Mid-size and smaller merchants are often unable to implement their own loyalty reward programs due to the high cost of the infrastructure required, including server computers that maintain user reward accounts and administration costs. For example, a small independent restaurant or pizzeria may want to award reward points and allow users to redeem accumulated reward points for free or discounted meals, but is unable to do so due to the aforementioned high costs involved. As mentioned above, some companies have resorted to purchasing reward points or miles from larger companies and then distributing them to their customers, but this does not help build brand loyalty for that company (e.g. MCI gives a customer 5,000 American Airlines points to change to their service, but the customer is not getting MCI-branded points).

It has therefore been desired to have a loyalty or reward point program that allows any merchant, regardless of its size, to award their own branded loyalty points and allow users to redeem them for their own products or services in order to build brand loyalty for that merchant. It has also been desired to allow users to selectively redeem their reward points at other merchants that are part of the network.

Although the building of brand loyalty by merchants of any size and stature is critical, it has also been recognized that users may end up with many different reward point accounts (one for each merchant at which purchases are made), each having relatively small numbers of points. It may take awhile for a user to build a meaningful sum of points with any one merchant, although there are great advantages to both the consumer as well as the merchant in doing so. It has also therefore been desired to provide a reward point system that allows users to aggregate reward points earned from these various merchants into a reward exchange account, wherein the aggregated reward points may be advantageously used to purchase goods or services from any selected merchant in the system.

The needs stated above have been met generally by a system and method as set forth in U.S. Pat. No. 6,594,640, SYSTEM AND METHOD FOR ELECTRONIC BARTER, TRADING AND REDEEMING POINTS ACCUMULATED IN FREQUENT USE REWARD PROGRAMS, which is owned by the assignee of this application and which is incorporated by reference herein. The '640 patent relates to systems and methods that allow for users to maintain individual reward point accounts with different rewarding entities, yet selectively exchange, combine or aggregate reward points as desired to provide increased value and purchasing power. In addition, the assignee has an additional series of issued continuation patents (U.S. Pat. Nos. 6,842,739; 6,820,061; 6,829,586; 6,947,898; and 7,096,190) and published continuation-in-part patent applications (including but not limited to US 2005/0021399A1, METHOD AND SYSTEM FOR ISSUING, AGGREGATING AND REDEEMING POINTS BASED ON MERCHANT TRANSACTIONS; US2005/0021401A1, METHOD AND SYSTEM FOR ISSUING, AGGREGATING AND REDEEMING MERCHANT LOYALTY POINTS WITH AN ACQUIRING BANK; and US2005/0149394A1, METHOD AND SYSTEM FOR ISSUING, AGGREGATING AND REDEEMING MERCHANT LOYALTY POINTS WITH AN ISSUING BANK) which describe various methodologies and systems for enabling merchants to use an existing network infrastructure such as a credit card network to provide individual reward programs that may be aggregated if desired based on various parameters and criteria as described therein.

It is therefore desired to implement a system and methodology that enables a broadcast television network to provide individual reward and incentive programs for each participating sponsor as well as its own programming that may be individually tracked and maintained, yet may be combined and aggregated as desired by the participating viewers, wherein the broadcast programming and associated advertisements play an important role in driving viewers to using the products and services of the participating sponsors and to view the network's programs, and wherein the efficacy of the associated advertisements may be accurately measured.

### SUMMARY OF THE INVENTION

As described herein, the present invention is a system and method for enabling a television broadcast network to implement a network-wide reward program. In this program, reward content is provided to the viewer by one or more of various ways, including but not limited to separate rewards promotions or programs, in association with a sponsor's ads, or in association with a television program itself. For example, sponsors may provide ad content as well as reward content that is associated with television programming content and broadcast to viewers. The viewers see the reward content and, depending on the type of the content, may respond in one or more of various ways. If the reward response criteria of the reward content are satisfied, then the viewer will be provided with an appropriate reward, which may be in the form of reward points stored in a reward account associated with the sponsor and/or the network, a prize, etc. Rewards such as reward points may be earned and stored in an account and then redeemed at a later time, or combined with points from other sponsors associated with the reward program, etc.

For example, as described further herein, a sponsor may provide reward content in the form of a question regarding the subject matter of the ad or programming content—such as if an ad relates to a new car, the question may ask the viewer a question about the car, the answer to which could only be obtained by listening to and/or viewing the commercial attentively. The viewer could then be directed to call in to a toll-free number to provide the answer, to enter the answer at a special web site, to enter a button on the remote control of an interactive television set, and/or to visit the local showroom for that car and tell a salesperson the answer. If the answer provided is correct, then the viewer would receive the reward or prize, which may be in the form of reward points credited to his account, a free poster of the car, or even a discount off of the price of the car, etc.

A system as provided herein that provides rewards to viewers based on the requirement that they view certain programs and/or commercials provided by the television network provides many benefits to the sponsoring network, to the participating viewers, and to the participating sponsors as well as any merchants that sell the sponsors' products. This invention enables the network and its sponsors to “attract eyeballs” and implement viewer loyalty, which are extremely desired in the television and advertising industries. This invention transcends individual merchant reward programs since it provides a mechanism to drive traffic to merchants associated with the ad sponsors and provide rewards tied to the merchants/sponsors own accounts, well as aggregation of rewards with related merchants/sponsors (referred to herein as “cluster marketing”).

The present invention as described herein is a tool for providing rewards to viewers that is embedded throughout the programming schedule as desired by the system operator (i.e. the television network). The reward content interleaved with the commercials and program content may be targeted to and tailored for specific market segments, such as sports, news, soap operas, game shows, documentaries, talk shows, comedy shows, etc. These types of reward content will appeal to different market segments in the same manner as does different types of programming and advertising.

The reward content may be in any format that would elicit some type of response suitable for establishing that a viewer has watched and/or listened to an advertisement or a certain part of a television show. Thus, the reward content may include clues that are embedded within the ad or show, questions, answers to questions, trivia, code words or numbers, etc. The reward content may be a directive to watch a different show to obtain further information, or it may be in the form of a scavenger hunt. The reward content may be a directive to call an 800 toll free number within a certain time frame to obtain a prize or reward points on the viewer's account. Likewise, the viewer may be instructed to visit a certain web site on the Internet in the same manner. The reward content may be generated and juxtaposed with ad content and/or programming content in a manner to effectively provide a network-wide sweepstakes or gaming environment.

As described below, when the reward consists of reward points, they may be associated with the sponsor, the network, an associated merchant of the sponsor, or any combination of the three. That is, a user may earn “BMW” reward points, or he may earn “SMITHTOWN BMW” reward points, or he may earn “NBC” reward points, or a combination of all three, by fulfilling the reward criteria as may be required.

Thus, the present invention will provide for customer acquisition and loyalty whereby the television network will be advantaged (since the loyalty program provides an incentive to view programs on that television network and not others), the product/service sponsors and merchants will be advantaged (since the viewer is watching the commercials to obtain reward content and related information), and the viewers will be advantaged (since they obtain rewards and prizes through the operation of the system).

This invention will enable the sponsors and network to leverage loyalty from one program to another program, via reward content associated with the program material itself or with commercial advertisements associated with the program material. This invention enables the system operator to monitor viewer behavior and then influence and modify it accordingly.

In addition to providing an incentive for viewers to modify their viewing habits to obtain rewards and make a purchase of goods or services to obtain rewards, the present invention may be adapted to provide an incentive for viewers to make donations to organizations that provide rewards in the same manner as described. Thus, noncommercial as well as commercial entities can benefit from this invention.

The reward system of this invention may optionally provide for a data collection process, such as via registration of the participating viewer.

Thus, the present invention is a method of operating a loyalty program in association with a television broadcast network. A television broadcast signal that includes reward content and television content (such as programming content and/or advertising content) is generated and then broadcast over a broadcast communications medium (such as cable, satellite, terrestrial, Internet, etc.) to a plurality of viewers. The viewers may each receive the broadcast signal via a receiving device operative with the broadcast communications medium (such as a cable TV box, a standard TV, an interactive TV, a PC, etc.). The reward content is obtained from the television broadcast signal and then output to the viewer via the receiving device. The viewer may then provide a reward response that is ultimately communicated to a reward server associated with the television broadcast network. The viewer is then provided with a reward in accordance with the reward response.

For example, the viewer may provide a reward response to the reward server by presenting a loyalty token (e.g. a loyalty card) to a merchant, wherein the loyalty token is linked to at least one reward point account stored at the reward server in association with the viewer. The merchant then communicates with the reward server to provide a reward request to the reward server, the reward request having an instruction to add reward points to the reward point account associated with the viewer.

The reward content may be a visual or audible cue, it may have sweepstakes entry information, it may be query requiring an answer, etc. The reward content may be interleaved with the television content such that it is viewed separately from said television content. In the alternative, the reward content may be integrated with the television content such that it is viewed at the same time as the television content.

Television content may be provided for a group or cluster of television shows, wherein the reward content associated with a first television show of the group or cluster of shows is cross-linked to at least a second television show of the cluster. In one case, the first television show has a first type of television content and the second television show has a second type of television content that is substantially different than the first type of television content (such as sports and news). In a second case, the first television show has a first type of television content and the second television show has a second type of television content that is substantially similar to the first type of television content (such as both sports shows). In this manner, a group of shows with a common theme such as sports may be clustered together such that a viewer may obtain rewards from a first sports show in the cluster, a second sports show in the cluster, etc. This may occur for the same sponsor or different sponsors if desired. Likewise, a viewer may be provide with an incentive to view programs of a different type, such as by offering a reward to a sports viewer if he tunes in to a news program and obtains related reward content from that show.

The present invention may be based on a loyalty network that provides for reward accounts stored on a reward server associated with the television network. A loyalty card may be provided to the viewers for use in this regard. The network may be a dedicated network, it may be Internet based, or it may utilize the pre-existing infrastructure of a network such as a typical credit card network (for example the VISA or MASTERCARD credit card networks). In this situation, a viewer visits a merchant (physically or online) and executes a purchase transaction at the merchant using a token such as credit card, a debit card or a smart card (other tokens such as loyalty cards may also be used). The viewer also presents the required reward response to the merchant, for example by entering an answer to a trivia question presented during an advertisement sponsored by the merchant being visited by the viewer. This may for example be entered into an appropriate point of sale (POS) device at the merchant that is adapted to work with this invention, or it may be entered into a web form as part of an online transaction. In the case of a credit card transaction, the merchant provides purchase transaction information to the acquiring bank with which it has contracted for credit card network services, and as known in the art, will get an approval or decline message after the acquiring bank contacts the issuing bank of the credit card used by the purchaser. A reward transaction record is also sent to the network reward server (which may be independent from the credit card network or which may be part of the credit card network). The user is awarded loyalty reward points based on the reward response given and optionally on the amount of the purchase (e.g. 100 points for a $100 purchase).

In one instance (referred to also herein as the central server embodiment), the functions of the network reward server are performed by a central server that resides on the credit card network and tracks the transaction between the merchant, the acquiring bank, and/or the issuing bank. A reward account is maintained in a database at the central server on behalf of the merchant/sponsor and the user, and the number of reward points in the user's account for that merchant is increased accordingly. The user may redeem the reward points earned from the purchase transaction with the merchant at a later time as part of a redemption purchase transaction, or may redeem the points with another approved merchant on the credit card network, or may aggregate those reward points with those of other merchants into a reward point exchange account, and then redeem the aggregated points for goods or services from any approved merchant on the network, depending on the configuration of the system.

In a second instance (referred to also herein as the acquiring bank embodiment), the reward account database is maintained in a database at the acquiring bank instead of the central server. Reward point transactions are executed at the acquiring bank in this case, as purchase (and redemption) transactions are executed.

In a third instance (referred to also herein as the issuing bank embodiment), the reward account database is maintained in a database at the issuing bank instead of the central server or the acquiring bank. Reward point transactions are executed at the issuing bank in this case, as purchase (and redemption) transactions are executed.

As a result, sponsors and merchants benefit since they are able to award loyalty reward points based on reward responses made by users without having to implement their own infrastructure; i.e. by using the pre-existing infrastructure of the credit card network with which they have a contractual relationship. Users will benefit since they will be provided with broadcast network loyalty programs previously unavailable to them due to the high cost of setup and administration of such programs.

### BRIEF DESCRIPTION OF THE DRAWING

FIG. 1 is representative of the prior art marketing arrangements used in reward programs;

FIG. 2 is a representation of the co-branded partners in a prior art award program;

FIG. 3 is a sample of the prior art reward summary from an airline frequent flyer system;

FIG. 4 is a block diagram of the components of the present invention;

FIG. 5 is a block diagram of the system components of the present invention;

FIG. 6 is a data flow diagram of the process for a user to redeem rewards;

FIG. 7 is a data flow diagram of the user request for purchase of an item at a merchant site;

FIG. 8 is a data flow diagram of the user account creation process on the trading server;

FIG. 9 is a data flow diagram of the offer process by a reward program or by a merchant;

FIG. 10 is a data flow diagram of the process where a user may be redirected from a reward program to the trading server of the present invention;

FIG. 11 is an illustration of the process flow in a typical credit card transaction that occurs over a credit card network;

FIG. 12A illustrates a credit card network;

FIG. 12B is an illustration of a database structure for the maintenance of merchant-issued loyalty points by a central server computer in accordance with the first (central server) embodiment of the present invention;

FIG. 13 illustrates a touchscreen POS device used with this invention;

FIG. 14 illustrates the interaction between users, merchants and acquiring banks in accordance with the second (acquiring bank) embodiment of the present invention;

FIG. 15 illustrates an alternative embodiment of a third party points aggregation service;

FIG. 16 illustrates points aggregation under the third (issuing bank) embodiment of this invention;

FIG. 17 is an illustration of a database structure for the maintenance of merchant-issued loyalty points by an acquiring bank in accordance with the second (acquiring bank) embodiment of the present invention;

FIG. 18 illustrates the interaction between users, merchants, acquiring banks and issuing banks in accordance with the third (issuing bank) embodiment of the present invention; and

FIG. 19 illustrates a block diagram of the television broadcast network loyalty system of the present invention.

### DETAILED DESCRIPTION OF THE PREFERRED EMBODIMENT

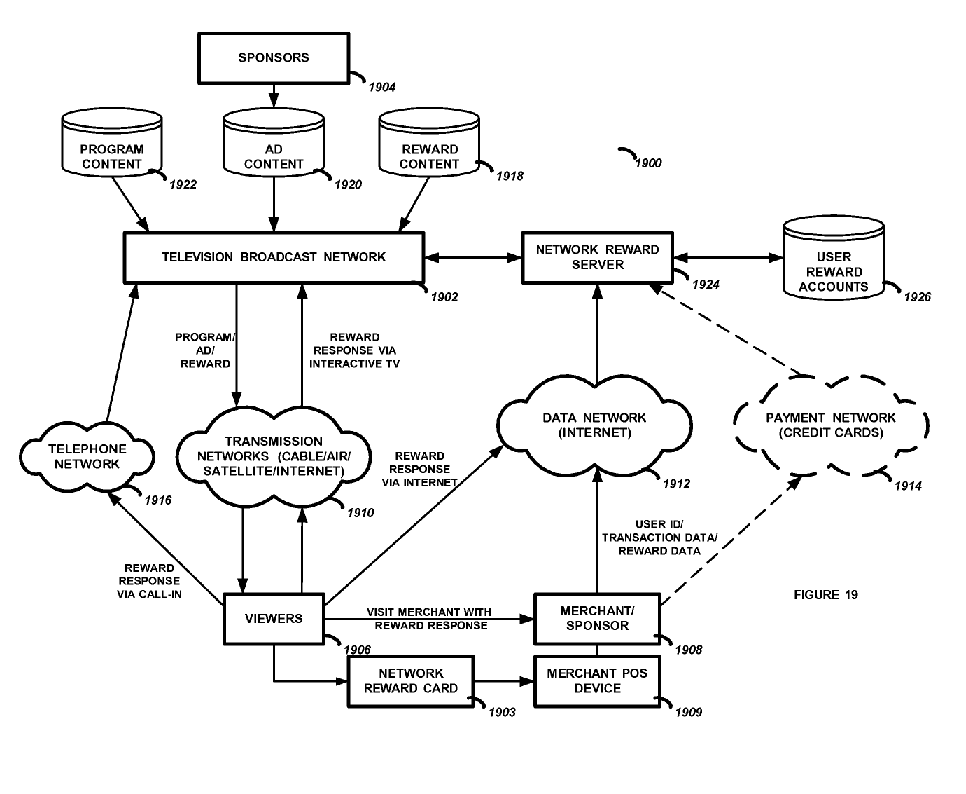

FIG. 19 illustrates a preferred embodiment of the present invention. The system 1900 includes several main subsystem components, which are a television network 1902, a group of participating sponsors 1904, a group of participating viewers 1906, and a group of participating merchant/sponsors 1908, all of whom communicate in various manners over one or more communications networks 1910, 1912, 1914, and 1916. The functionality and operation of each subsystem will now be described in detail.

The television network 1902 represents a television station, provider or network of virtually any size, but will be referred to herein as the television network. The function of the television network 1902 is to provide television broadcast signals for transmission to the viewers 1906 in one or more of various known media, including but not limited to over-the-air (terrestrial) broadcasts, cable TV, satellite TV (e.g. DISH NETWORK or DIRECTV), streaming video over the Internet, and the like. The distribution of the television broadcast signals via these various media is well known in the art and need not be repeated herein. In addition, the operation of the present invention generally does not rely on the particular medium being employed to transmit the broadcast signals unless specifically mentioned herein. Thus, the television network 1902 may include whatever computer hardware and software and other operational equipment such as signal transmitters as may be required to provide the broadcast signals to the viewers via the appropriate channels.

The term television broadcast signal encompasses television programming signals that are broadcast generally, such as prime time television shows, live sporting events, etc., as has been done in the television industry for decades. This term also encompasses the use of on-demand television signals available for example through digital cable television systems and satellite television systems, wherein a television show may be selected from a library of available programs (e.g. HBO ON DEMAND etc.). To the extent applicable in the present invention, reward content may also be provided in this type of programming scenario. Likewise, newer technologies that utilize data networks such as the Internet for providing programming content with a streaming or other type of distribution technology is also encompassed by the term television broadcast signal, assuming it carries the reward content as will be further described herein.

The viewers 1906 are equipped with one or more television receiving devices as known in the art, which interoperate with the selected transmission network to receive the broadcast television signal. A typical example would be a standard television receiver that receives terrestrial signals via an antenna, or cable television signals via a coaxial cable as well known in the art. Likewise, the use of a set top box, also known as a cable TV decoder, is also encompassed by this system. Television receivers may be standard definition, enhanced definition, or high definition, as the case may be. Satellite receivers that interoperate with television monitors are also used with this invention. As described above, newer technologies that allow streaming of television programming on demand or otherwise will allow a viewer to use a personal computer (or laptop computer, PDA, cell phone, etc.) to receive the applicable television signal. Thus, any type of receiving device/monitor that is interoperable with the television broadcast medium being employed is used with the present invention as described.

The present invention may operate in several different modes for providing reward content to viewers, based on the desires of the system participants—the broadcast network, the programmers, the sponsors, the merchants, the manufacturers, as well as the viewers themselves. A first embodiment will now be described that demonstrates a first aspect of the invention.

In this case, reward content 1918 will be integrated with advertising content 1920 provided by a sponsor. Both the reward content and the ad content are made available to the television broadcast network in separate or integrated form. The reward content in this example is a textual message that is displayed at the bottom of the screen for the duration of the ad as it is played to a viewer. For example, the text may provide a keyword, a code number or the like, with a directive to the viewer to make note of the information. The text will be associated in some manner with the sponsor, and may include a directive to visit the sponsor to obtain a reward. Thus, the ad may be sponsored by BMW for a BMW car, and the text may state: VISIT YOUR LOCAL BMW DEALER IN THE NEXT WEEK AND TELL THEM THE FOLLOWING NUMBER: 1738475”. Similarly, the ad may be co-sponsored by a movie studio and Best Buy stores for a new DVD movie release such as Star Wars VII, and the text may state: BRING YOUR STAR WARS LOYALTY CARD TO BEST BUY TODAY AND TELL THEM CHEWBACCA SENT YOU”. In another example, the sponsor may be Apple Computers, and the ad may depict a new ipod device, and the text may state: “LOG ONTO APPLE.COM AND ENTER THE COLOR OF THE IPOD IN THIS AD AND GET A FREE DOWNLOAD OF A NEW SONG”. In another example, the sponsor may be Hertz Car Rentals, and the ad may be for a weekend rental rate, and the text may state: “MAIL OR FAX YOUR BUSINESS CARD TO US TO GET A SPECIAL REWARD”. Another example is useful in an interactive TV scenario, where viewers are able to use their remote controls to send data upstream (such as in the video-on-demand environment). In this case, the sponsor may be NBC networks, and the ad may relate to the upcoming Super Bowl telecast on NBC, where the text may state: “PRESS 1 ON YOUR REMOTE CONTROL NOW TO OBTAIN A SPECIAL REWARD”. In all of these examples, the reward content is integrated with the advertisement itself and provides visual (or audible) instructions to undertake a certain act in order to obtain a reward. The acts requested may be different, however, such as where the act may be visiting a merchant associated with the sponsor (the BMW showroom) and providing information orally; it may be visiting a merchant that is a co-sponsor of the products being advertised (the DVD/Best Buy store) and providing a loyalty token for obtaining a reward; it may be logging onto a web site associated with the sponsor to obtain a reward (Apple); it may be sending (mail or fax) a physical item to evidence the reward (the Hertz/business card scenario); or it may be using an interactive TV remote to enter the required information upstream (the NBC scenario). Thus, as can be seen, there are many different modalities available for requiring a response from the viewer in order to obtain his or her reward.

The first scenario, where the text will be associated in some manner with the sponsor, and may include a directive to visit the sponsor to obtain a reward, will now be reviewed in further detail. As stated above, the ad may be sponsored by BMW for a BMW car, and the text may state: VISIT YOUR LOCAL BMW DEALER IN THE NEXT WEEK AND TELL THEM THE FOLLOWING NUMBER: 1738475”. The viewer, upon seeing this on the screen, and assuming he or she is desirous of obtaining the reward, will visit the designated BMW dealer, and at some point tell a salesperson there the reward code “1738475”. He may also be required to provide other information, such as name, address, email account, etc., which data is collected for subsequent marketing purposes. At this point, the salesperson will likely have to confirm the reward, by reference to a designated information source, such as an internal memo or the like. The salesperson may also be required to interact in real time with a rewards server computer 1924, which is associated with the reward program operated by the television broadcast network as shown in FIG. 19. The salesperson may do this by phone or through a web site operating in association with the network reward server 1924, where the salesperson would log in and enter the reward criteria (the code given and an identification of the viewer, which may be name or a unique ID number). Then assuming that there is a match between the code given and the reward criteria stored at the server 1924, then the reward will be approved. In one scenario, the reward is provided in real time, such as by giving the viewer a free gift (e.g. a BMW cap). In another scenario, the viewer is provided with reward points in an account. The account may be associated with the sponsor (BMW) and/or with the broadcast network (e.g. NBC). These reward points may be accumulated, aggregated, and redeemed, as further described. The use of a reward account may be more readily adapted to a scenario where repeated purchase may be made (such as the BEST BUY scenario described next), so in this case the simple real time reward of a gift may be more suitable.

Thus, the main components of the invention: providing reward content to the viewer, the viewer fulfilling the reward criteria by visiting the showroom and providing the reward code that was displayed on the screen, the merchant/sponsor confirming the reward with the reward server, and the viewer obtaining the reward as a result, are all exhibited in this scenario.

In the next scenario, the ad may be co-sponsored by a movie studio and Best Buy stores for a new DVD movie release such as Star Wars VII, and the text may state: BRING YOUR STAR WARS LOYALTY CARD TO BEST BUY TODAY AND TELL THEM CHEWBACCA SENT YOU”. Thus, the viewer will see an ad for the new Star Wars movie on DVD, and the text will instruct him that he can purchase the DVD at Best Buy and give them the code phrase—Chewbacca sent him—to get his reward. When he visits Best Buy and purchases the DVD, he presents loyalty card 1903, which may be branded by the television network, by Best Buy, by the movie studio, or any combination of these entities. The viewer, at check out, swipes his loyalty card at the POS terminal, and inputs the code phrase (or tells it to the clerk who does the same). While the transaction is being approved, a reward request message is sent from the POS terminal over a data network (which may be the Internet, a dedicated network, or even the credit card network) to the reward server computer 1924. There, the reward transaction data is verified, and if approved, the reward is given to the consumer. As with the BMW scenario above, the reward may be a prize given to the viewer at that time—such as a poster of the movie, etc. In the more likely case, the viewer will have reward points credited to his reward account associated with the loyalty card and stored at the reward server. Since the viewer is likely to make further purchases at Best Buy, the use of an a reward account with accumulating reward points is preferred. In the alternative, the reward may be provided to the viewer without requiring a purchase, i.e. simply by showing up at the store and presenting his card, and then giving the designated code (“Chewbacca”) to a clerk. As an additional alternative, a code word need not be supplied, and the reward may be provided accordingly.

In the third example, the sponsor may be Apple Computers, and the ad may depict a new iPod device, and the text may state: “LOG ONTO APPLE.COM AND ENTER THE COLOR OF THE IPOD IN THIS AD AND GET A FREE DOWNLOAD OF A NEW SONG”. Thus, the viewer watches the iPod commercial and is prompted to use his computer to log into the designated web site www.apple.com. After logging in to the web site, a link, text entry box or the like is provided where the viewer may enter the specified information (the color of the iPod in the commercial). This requires the viewer to pay attention to the substance of the commercial that is associated with the reward content. That is, if the viewer does not pay attention to the commercial, he will be unable to enter the correct color information (unless he guesses correctly). Upon entry of the correct iPod color, he may be prompted to enter his user information, which may be an account identifier and password, so he can download the free song as his reward. In the alternative, his reward points account may be credited with reward points in the same manner as descried above. This scenario therefore does not require the viewer to physically visit a store of the sponsor, since it allows online access to the reward site. In addition, this scenario differs from the first two above in that it requires the viewer to be attentive to the substance of the commercial itself, in addition to the reward content displayed on the screen.

In the fourth scenario provided above, the sponsor may be Hertz Car Rentals, and the ad may be for a weekend rental rate, and the text may state: “MAIL OR FAX YOUR BUSINESS CARD TO US TO GET A SPECIAL REWARD”. This does not require the viewer to physically visit a store location or use a computer, but only require shim to use mail or fax services to provide something to the reward service. In this case, he is asked to send in a business card, which will give the reward service vital information for subsequent marketing purposes. The viewer may obtain a reward as a result that may be in the form of reward points as described above, a credit for a weekend rental, etc.

In the fifth scenario described above, the viewer uses his remote control device in an interactive television embodiment to send data upstream. In this case, the sponsor may be NBC networks, and the ad may relate to the upcoming Super Bowl telecast on NBC, where the text may state: “PRESS 1 ON YOUR REMOTE CONTROL NOW TO OBTAIN A SPECIAL REWARD”. By selecting the designated control, data is provided upstream from the viewer that may be logged and cause the reward server 1924 to increase the associated reward account of the viewer. In an alternative embodiment, a dedicated device may be provided to viewers that functions as a regular remote control for controlling the television, and also as a wireless communicator that is capable of sending data to a emote location. For example, a cellular device using an SMS (short message service) technology may be implemented to provide data transmissions to the central location that indicate input selections made by the viewer, thus enabling the awarding of reward points as described.

In a preferred embodiment, reward content may be displayed to a viewer in a pop-up or scrolling fashion. Thus, a viewer may be watching an advertisement or a program, and a pop up display will appear with information regarding the reward opportunity. By using the pop up (or scrolling) approach, the viewer's attention will be readily obtained, thus further increasing the value of the reward system.

In the preferred embodiment, reward points are credited to a reward account stored on behalf of the user by the rewards server. As indicated herein, reward points may be obtained in various ways based on the parameters of the reward program. A key criteria is to provide an incentive to the viewer for watching an advertisement (or a program) in order for them to obtain the reward points. The above examples provide several ways for a viewer to be able to obtain the desired reward points. Once a viewer has accumulated a predetermined number of reward points, he may redeem them for something of value as described further herein. For example the program may specify that a viewer may redeem 10,000 reward points for an entry into a sweepstakes, or the viewer may redeem 5,000 reward points for an item associated with a certain sponsor, etc.

As described, one key aspect of this invention is the ability to cross-pollinate viewing of various programs. Thus, an advertisement may be provided that urges the viewer to watch another television program. By viewing the second program, the viewer will have an opportunity to earn reward points in various ways. For example, the first advertisement (or program) may provide a first piece of information, and the second program to which the viewer is steered may have a second piece of information, whereby reward points may be obtained only if the viewer has both pieces of information. Thus, a baseball program viewed by a viewer may provide an advertisement (here, the sponsor is the network) that states “TODAY'S CODE IS 1234; IF YOU WATCH the NFL GAME OF THE WEEK TONITE YOU CAN GET THE MISSING NUMBERS”. On viewing the NFL Game of The Week, an advertisement is played that states “TONITE'S CODE IS 5678; LOG INTO WWW.NETWORKREWARDS.COM NOW AND ENTER YOUR BASEBALL CODE WORD AND YOUR NFL CODEWORD AND RECEIVE 1,000 REWARD POINTS”. Thus, the viewer that has watched both programs (the baseball game and the NFL game) can enter both code words into the web site and obtain 1,000 reward points (he would also have to enter his account number to obtain the reward points).

In the above example, a baseball show was utilized to drive viewership to a football program on the same network. It may also be desired to drive viewers to programs of a different type in order to attract new viewers to the different program. Thus, in the example above, the second show may be a news broadcast, or it may be an entertainment show, etc.

In addition to using sponsored advertisements as a vehicle for conveying reward information to viewers, the present invention implements an embodiment wherein reward information is conveyed in association with a television program itself in one or more of various manners as further described herein.

In one aspect, the reward content 1918 may be displayed along with program content 1922 while it is playing, much in the same manner as described above with ad content 1920 in the advertisement embodiments. That is, a textual message may be superimposed on top of a program, such as a baseball game, inviting the viewer to perform a certain act such as log into a rewards web site or watch another program in order to obtain reward points. In another aspect, the reward content may be integrated into the television program itself. This may take many forms, such as a game show that invites audience participation wherein the winners may obtain reward points. For example, an entertainment trivia game show may be shown, wherein a celebrity host asks viewers as well as celebrity guests questions about a recent movie (this may be co-sponsored by the movie studio if desired) or about another television show on the same network. The viewer may log into a web site or call in with their answers, and if they are correct they will win reward points into their account. This game show concept may be expanded to become a rewards show, wherein various parameters are fulfilled that enable viewers to obtain rewards as described.

In another aspect of the invention, the television network, associated sponsors, merchants, and manufacturers that participate in the rewards program are able to obtain valuable data from the program regarding the participating viewers. Data may be obtained from viewers in one or more of various modes. First, data may be obtained as a result of a registration process, wherein the viewer is required to provide certain data in order to participate in the reward program. This may be collected via a web site, call in, mail in, at a merchant location, etc.

In addition, data may be collected from viewers at any point in the participation process. For example, assume a viewer has logged in to the system in order to enter two code words, each of which has been supplied by to cross-linked programs as described above. At that point, the viewer may be asked to respond to a brief survey in order to obtain his reward points. The survey would likely be based on the programming he has just viewed, perhaps asking the viewer his rating of the show, suggestions for improvement, favorite characters, etc. This data is of course quite valuable to the television network as well as sponsoring companies.

Data may also be collected regarding the viewer's viewing habits as evidenced by the request to obtain reward points. That is, assume that a viewer logs in to the reward web site to obtain reward points from a certain show. These reward points may of course be traceable to that show since the data entered by the user to obtain the points would be linked to that show by the program operator. So, when the viewer enters code “12345”, the system will understand that the viewer has just watched a certain new show, since that code word was provided during broadcast of that new show.

Data may also be collected regarding the user's shopping habits when he interacts with a sponsor or merchant in order to obtain and/or redeem reward points. This data along with the data described above, will prove quite valuable in assembling a viewer profile for subsequent marketing analysis, tracking, and related analytics.

As previously mentioned, and with respect to FIG. 19, reward points may be earned into one or more reward points accounts 1926 that are maintained in a reward server computer 1924 in association with the television broadcast network 1902 or a third party that operates the server on its behalf. For example, if the NBC television network operates the system of this invention, then viewer John Smith will have an account 1926 at NBC's reward server 1924 that will store the amount of reward points earned or otherwise accumulated by John Smith for activities that are related to programs and advertisements associated with NBC as described above. The viewer will be able to redeem those points as desired in a manner described below.

As shown in FIG. 19, data regarding the reward transactions, as well as any related transactions such as purchases, will be transferred to the reward server computer 1924 in one or more of various ways, depending on the nature of the transactions involved. One primary embodiment will use a data network 1912 such as the Internet for transferring reward transaction information. This will be applicable, for example, if a viewer 1906 is prompted to log into a web site operated by a rewarding entity in order to obtain reward points (or other prizes), such as if a reward promotion is displayed that prompts the viewer to log into www.nbc.com to enter the special code provided and receive 100 reward points. Likewise, the telephone network 1916 would be used if the viewer were required to call in such as by an 800 toll free number.

Similarly, a merchant/sponsor 1908 may utilize a data network 1912 in order to provide reward transaction data to the network reward server 1924. In this case, for example, the viewer visits a BEST BUY location and provides reward information (e.g. the secret code given in an advertisement), which may be during a purchase transaction for an associated product. The viewer may present a loyalty card (which may tied into a credit card, as described below) to a merchant POS device 1909, and the card will contain the viewer's identification information such as an account number. The required information will be sent via the data network 1912 to the network reward server 1924 for processing. In the alternative, a pre-existing network infrastructure, such as a credit card network 1914, may be utilized instead of or as a supplement to the Internet 1912. This is particularly useful when the reward points are provided as part of a product or service purchase at a participating sponsor 1908, since the viewer will present his credit (or debit) card as part of the purchase transaction, and since transaction information will be processed by the credit card network 1914 regardless of the existence of a reward component. Thus, adapting the credit card network 1914 to perform functions of the reward component of this invention is advantageous. This will be described further below.

In an alternative embodiment, radio services may be used separately or as an adjunct to the television broadcasts. In this mode, only audible prompts would be broadcast, with advertisements and/or regular programming as described above. For example, a sports show talk host could tell the listener to call in to an 800 toll free number to obtain 500 reward points in his listener account. Likewise, an advertisement for a BMW car could have a similar prompt during playback of the ad. These reward broadcasts could be done over terrestrial radio transmissions, satellite radio transmissions, streaming audio over the Internet, etc.

In addition, to using the radio broadcast as a stand-alone system, radio broadcasts could be used to supplement a television broadcast reward promotion. For example, a radio ad played during the day hours could provide half of a reward code as well as an instruction for the listener to tune in to a certain television show that evening and obtain the other half of the reward code in a manner similar to that described above. Thus, radio is used herein to provide an incentive to listen to another radio show or television show (and television could be used to provide an incentive to tune in to a radio show for similar rewards.

In addition or as alternative to using a single main reward account for storing all reward points earned through the broadcast network for all activities carried out with respect to its shows and advertisements, the system may be configured to provide multiple reward accounts, each of which would be associated with a separate television channel, or each of which could be associated with a separate television show, or a cluster of shows and/or channels, etc. Thus, for example, one permutation would provide a reward account for all rewards earned through viewing programs and advertisements shown on NBC. In another example, a reward account would be provided for all points earned through viewing all sports shows on the network regardless of the channel it may be shown on. In another example, a reward account may be provided for all points earned only for the show NBC EVENING NEWS. In another example, special promotions are established where reward points are stored in a separate account for all points earned through cross-linked program/advertisement promotions as described above. In addition to providing separate accounts, points may be earned into one account associated with the network but tagged in the database in order to distinguish the various features described above (single channel, single show, multiple shows, etc.) so that filters may be employed to determine how points have been allocated. Thus, virtually any configuration of managing and accounting for reward points may be adopted in this invention as desired.

In one aspect of the invention, viewers having multiple reward point accounts may redeem accumulated points from each account independently. That is, a viewer could redeem 1,000 NBC reward points for an NBC-sponsored prize such as a coffee mug. The viewer might redeem 5,000 reward points sponsored by APPLE, through its commercials, for a free song download over the Internet. The viewer might redeem 10,000 reward points from a series of BEST BUY commercials for a free DVD at a BEST BUY store or online, etc. In these examples, reward point accounts sponsored by a defined entity are redeemable with that entity (or with a third party associated with that entity).

In an alternative embodiment referred to as point aggregation, viewers are able to aggregate or pool reward points from two or more individual reward accounts in order to redeem them for an item, wherein they would have been unable to obtain that item with points from either account separately. For example, a viewer may have 2,000 NBC points and 3,000 EVENING NEWS points, neither of which might be enough for a prize of any merit. However, under this embodiment of the invention, the viewer could aggregate his points in one or more of various means, to yield 5,000 equivalent total points, which might then be redeemed for something of greater value. This methodology is described in detail in U.S. Pat. No. 6,594,640, SYSTEM AND METHOD FOR ELECTRONIC BARTER, TRADING AND REDEEMING POINTS ACCUMULATED IN FREQUENT USE REWARD PROGRAMS, which is owned by the assignee of this application and which is incorporated by reference herein. The '640 patent relates to systems and methods that allow for users to maintain individual reward point accounts with different rewarding entities, yet selectively exchange, combine or aggregate reward points as desired to provide increased value and purchasing power.

One way to provide for reward points aggregation would be to provide a separate exchange account, which could be managed for example by the broadcast network itself. In this case, for example, NBC would establish an exchange account for the viewer, and then reward point exchange transactions as requested by the viewer so that he could pool his rewards from other accounts (e.g. from his news account and from his sports account) accordingly. In another example, reward points could be traded from his sports account directly into his news account. In both examples, an exchange rate would be employed that would dictate the number of points the user would obtain in one account as a function of the number of points he must surrender in the other account. These aggregation and exchange techniques are fully described in the '640 patent described above.

In addition to the '640 patent and the continuation patents that have issued based on the '640 patent, the present invention may in one embodiment build on an infrastructure also described in the applicant's co-pending application Ser. No. 11/424,407, METHOD AND SYSTEM FOR ISSUING, AGGREGATING AND REDEEMING MERCHANT REWARD POINTS WITH A CREDIT CARD NETWORK, the specification of which is incorporated by reference herein. In the '407 application, a system and method are described that enable a reward program operator to implement its program using an existing credit card network, wherein individual merchants provide separate yet combinable reward accounts via the network. As explained herein, this methodology might readily be adapted to operate with the present invention if desired, wherein separate reward accounts are established for programs, sponsors, etc. as described herein.

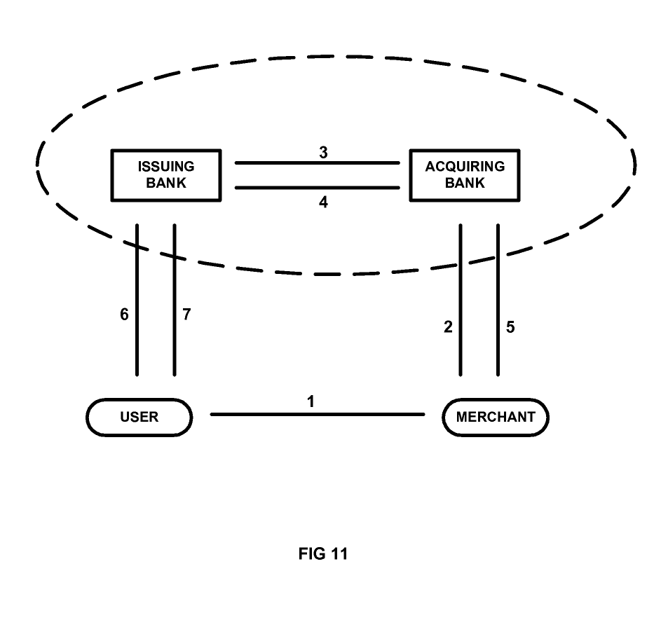

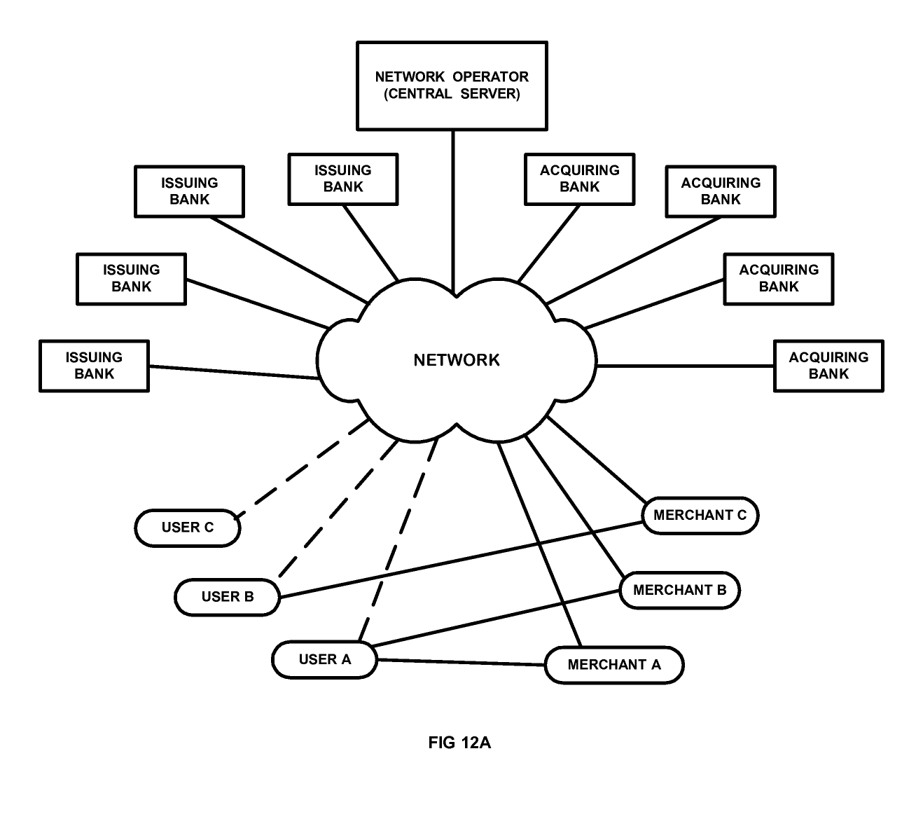

Referring to the '407 application, a pre-existing credit card network infrastructure is utilized to provide merchant-branded reward point accounts for users making purchase transactions with those merchants. FIG. 11 illustrates a typical prior art credit card network and a credit card based purchase transaction between a user and a merchant. The credit card network is comprised of thousands of member banks, wherein a member bank may be an issuing bank (issuer) or an acquiring bank (acquirer), or it may fulfill the role of both issuer and acquirer. A consumer or user has a contractual relationship with an issuing bank, which will issue the user a credit card such as a VISA card based on finance terms agreed to between the user and the issuing bank. The user will present the credit card when he desires to make a purchase transaction with a merchant (flow 1). The merchant has a contractual relationship with an acquiring bank, which will agree to pay the merchant after the transaction is approved. When the user presents his credit card to the merchant, the merchant will contact its acquiring bank and request approval of the transaction via the credit card network (flow 2). This is typically done by the merchant swiping the credit card into a POS (point of sale) terminal, but it may be done manually (i.e. over the telephone) as well. In addition, e-commerce sales over a global computer network such as the Internet or an interactive television system may be used under this system. Once the acquiring bank has received a transaction request from the merchant, it determines the issuing bank of the credit card (from the credit card information) and then contacts the issuing bank for approval (flow 3). The issuing bank and the acquiring bank are a part of the credit card network, which may have tens of thousand of such member banks. The infrastructure of the credit card network allows for transactions between acquiring banks and issuing banks as described herein as is well known in the art.

Once the issuing bank receives a transaction request from the acquiring bank, it determines if that user has enough credit to allow the purchase. If the purchase is deemed to be allowed by the issuing bank, it sends an approval message to the acquiring bank (flow 4), and the acquiring bank in turn sends an approval message back to the merchant (flow 5). The purchase transaction may then occur. The issuing bank will pay the acquiring bank the amount (i.e. the requested purchase price) minus an interchange fee (e.g. 1.4% of the price). The acquiring bank will pay the merchant the amount received from the issuing bank minus its own fee (e.g. 0.6%). Thus, the merchant will receive the purchase price minus the entire merchant discount of 2%. For a $100 sale, the merchant will receive $98, the issuing bank retaining $1.40, while the acquiring bank retains 60 cents.

The issuing bank will request payment of the full purchase price from the purchaser, typically in a credit card statement that is issued monthly (flow 6). The risk of collection of the purchase price from the consumer is borne by the issuing bank. The user will pay the issuing bank (flow 7), often on a revolving basis with interest attached.

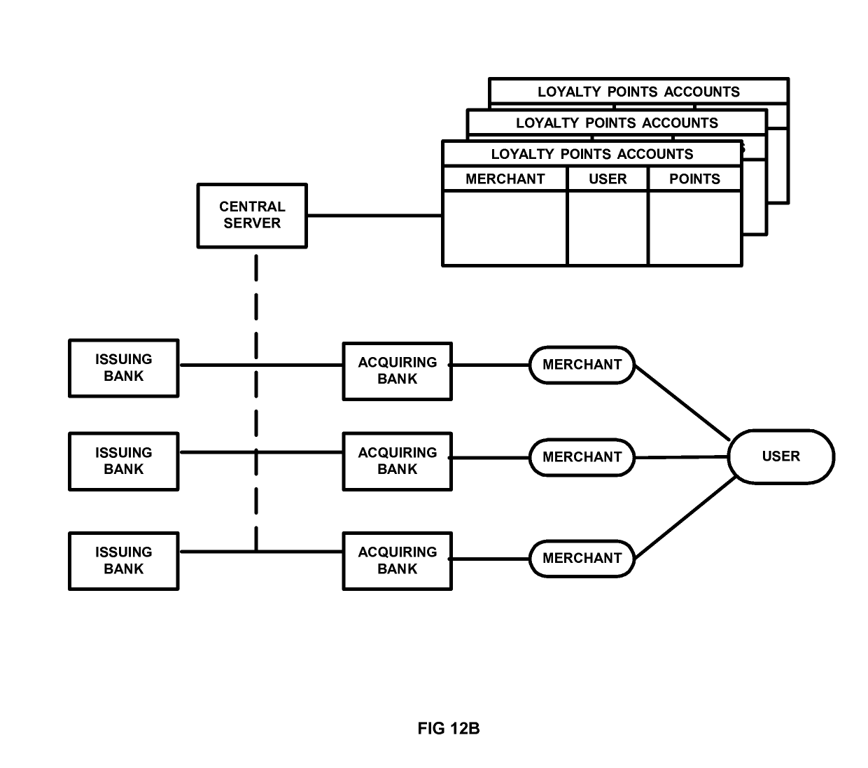

FIG. 12A illustrates a typical credit card network, in which numerous acquiring banks, issuing banks, and merchants intercommunicate with each other as described above via a communications network as shown. FIG. 12A also illustrates how a user typically communicate with merchants directly, but may also interconnect to the network (via the dotted lines) under this invention to interoperate with the user's reward point accounts to check the point balances, control point aggregation, and effect redemption, all as will be described further below.

This type of credit card network thus provides for a merchant to need only one contractual relationship—that with the acquiring bank (and/or the credit card network operator). The merchant is not required to seek payment from the thousands of issuing banks directly—that task is performed as a result of the network architecture. Likewise, the consumer need have only one contractual relationship—that with the issuing bank. The consumer is not required to promise payment to the thousands of acquiring banks directly—that task is performed as a result of the network architecture. These types of credit card networks currently enable over two trillion dollars to be exchanged per year as a result of credit card purchases, and the present day economy would not operate as it does without such networks.

The present invention leverages this pre-existing credit card network and the relationships between member banks to provide for reward point accounts and transactions not possible in the prior art due to their high costs if operated independently as done by large entities such as airlines and hotel chains. In this invention, the merchant is desirous of awarding loyalty or reward points to a purchaser for the purchase of its products or services. The merchant wants to award reward points that are directly branded and issued by that merchant, rather than having to purchase reward points from a larger entity such as an airline and distribute them to their customer as in the prior art. Three exemplary embodiments of the present invention utilize the credit card network; a first (central server) embodiment, a second (acquiring bank) embodiment, and a third (issuing bank) embodiment, all of which are described herein.

In the first (central server) embodiment of this invention, a central server computer will monitor transactions over the network between acquiring banks and issuing banks and determine if loyalty points are to be logged into an account at the central server based upon information contained in the exchanged data. In the second (acquiring bank) embodiment, the merchant will leverage the account with the acquiring bank that it already has a contractual relationship with for purposes of the credit card network by providing purchase transaction information to the acquiring bank, as part of the credit card purchase transaction previously described, so that the purchaser who presented the credit card will receive loyalty points (also referred to herein as reward points) based on the transaction at a predetermined rate, such as one point per dollar spent, which will be stored at the acquiring bank. Likewise, in the third (issuing bank) embodiment of this invention, the merchant will leverage the account with the acquiring bank that it already has a contractual relationship with for purposes of the credit card network by providing purchase transaction information to the issuing bank, via the acquiring bank, as part of the credit card purchase transaction previously described, so that the purchaser who presented the credit card will receive loyalty or reward points based on the transaction at a predetermined rate, such as one point per dollar spent, which will be stored at the issuing bank.

For example, for a $100 purchase, the purchaser will receive 100 points in an account under his name (or other identification indicia—likely his credit card account number). The merchant may inform the purchaser that he has received 100 of that merchant's reward points based on the transaction. In fact, the merchant will likely advertise that he is awarding reward points under his brand for purchases made at his store. For example, an electronics store such as BEST BUY will advertise that a $100 purchase will yield 100 “BEST BUY Points” for a purchaser. The merchant here is able to provide this feature without having to establish an expensive infrastructure (i.e. server computers, administrators, etc.) as in the prior art. Likewise, it is able to award its own branded reward points as not seen before in the prior art (rather than simply distributing airline points or hotel points). In addition, in the case wherein the credit card network operator operates the central server (e.g. VISA or MASTERCARD), the network operator may be co-branded with the local merchant awarding the reward points (in the central server embodiment), or the acquiring or issuing bank (e.g. MBNA or CITIBANK) may be co-branded with the local merchant awarding the reward points (in the acquiring bank embodiment or the issuing bank embodiment). Thus, the reward points may be referred to as “BEST BUY/CITIBANK Points”, or “BLOCKBUSTER/MBNA Points”, or “GAP/FLEET Points”, etc.

The merchant is thus able to leverage its pre-existing contractual relationship with the acquiring bank and the credit card network, and either the central server (in the first embodiment) or the acquiring bank (in the second embodiment) or the issuing bank (in the third embodiment), will keep track of the loyalty points awarded by the merchant to all of its customers. Similarly, hundreds or thousands of similar accounts with other customers and merchants will be kept track of in the same manner.

In the first (central server) embodiment, the maintaining of these merchant loyalty points may be undertaken by storing user and merchant account information in a database associated with the central server as shown in FIG. 12B. Thus, FIG. 12B illustrates a simple database format wherein each merchant and user under that merchant has a record which indicates how many points are in the account, as well as other optional information (such as par value of points, restriction on use, etc.) The format of the storage of the information is unimportant and may take many forms as well know in the art of relational and other types of databases. A simple transaction log may keep information on each transaction processed by the acquiring and issuing banks; this log may be easily modified to include loyalty point information as well. Thus, there may be a setup fee charged by the credit card network operator to initiate the loyalty program for a merchant, as well as transaction fees that provide for a small percentage of revenue to the credit card network operator for each transaction made by the central server.

Preferably, the user is able to view his loyalty point account balance by logging into a web site run by the central server. Optionally, the merchant may have a link on its web site so that the user can check his account, or there may be a redirection to the central server web site, etc. The user may also be able to place a telephone call and, using well know techniques for acquiring information via DTMF tones or audible instructions, obtain account information. The purchaser need not even know that the account is being held for him by the central server since the central server will operate in the “back office” aspect of this invention, thus rendering the specific procedures transparent to the user and providing a great ease of use of the system.

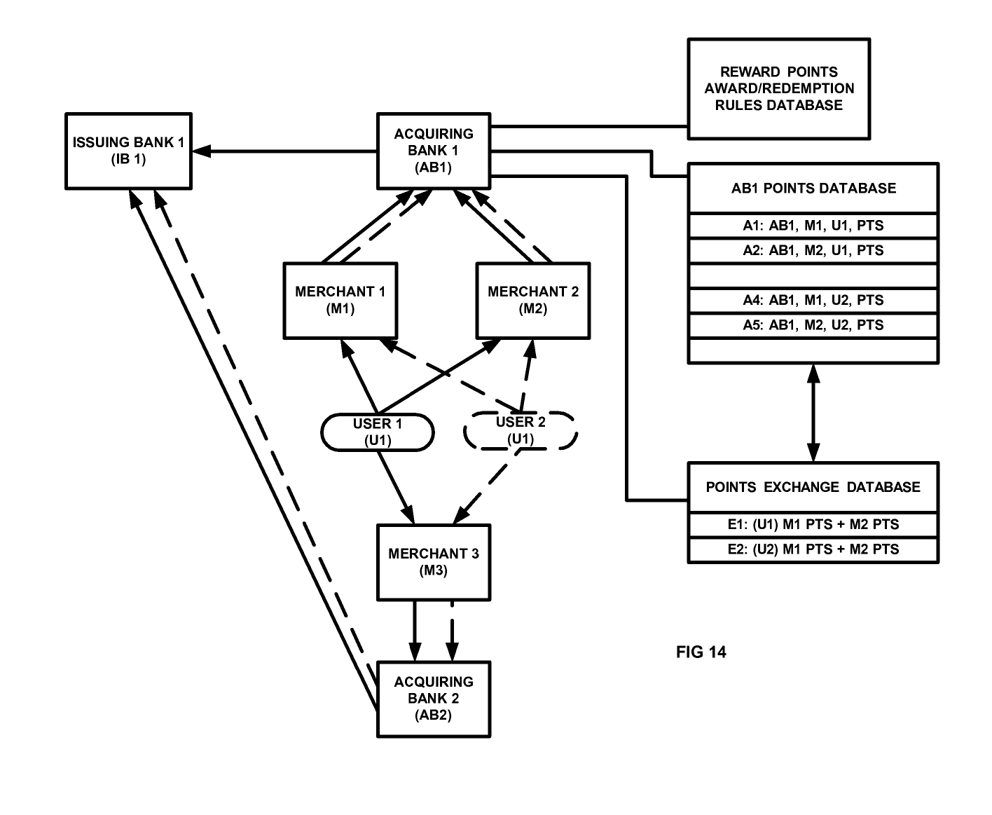

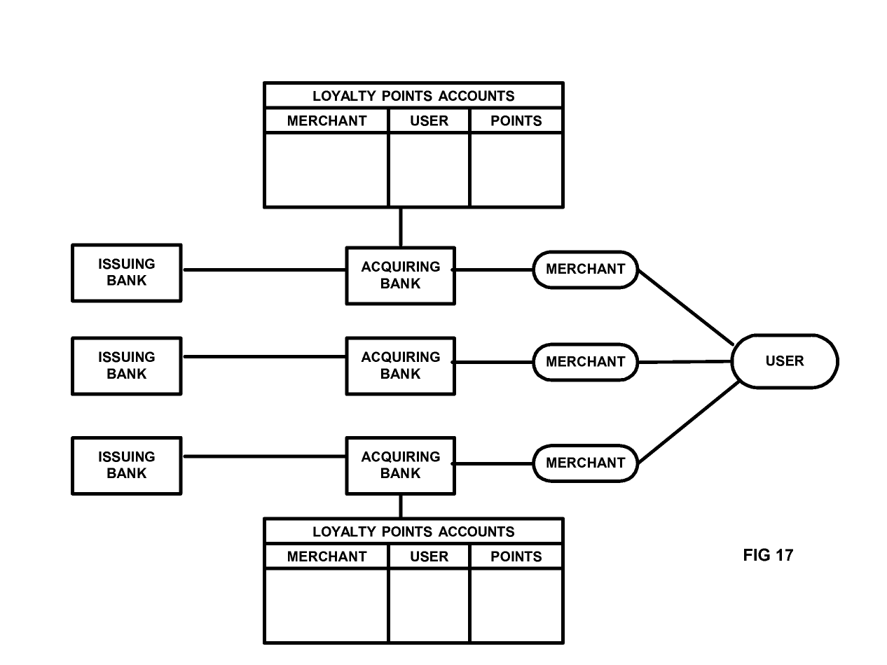

Similarly, in the acquiring bank embodiment, the maintaining of these merchant loyalty points may be undertaken by storing user and merchant account information in a database associated with the acquiring bank as shown in FIGS. 14 and 17. Thus, FIG. 14 illustrates a simple database format wherein each merchant and user under that merchant has a record which indicates how many points are in the account, as well as other optional information (such as par value of points, restriction on use, etc.) The format of the storage of the information is unimportant and may take many forms as well know in the art of relational and other types of databases. A simple transaction log may keep information on each transaction processed; this log may be easily modified to include reward point information as well. Thus, there may be a setup fee charged by the acquiring bank to initiate the loyalty reward program for a merchant, as well as transaction fees that provide for a small percentage of revenue to the acquiring bank for each transaction.

The acquiring bank may set up the accounts with each merchant as desired. That is, an acquiring bank such as MBNA may agree with a merchant such as BEST BUY that every time a user purchases an item at BEST BUY, MBNA will allow for a reward point account to be opened and increased for that particular user and for BEST BUY transactions only. In one case, there may be a requirement that a specific instruction be sent from BEST BUY to MBNA (typically as part of the credit card transaction) in order for points to be awarded. Thus, there would be an instruction from BEST BUY to MBNA that User A should have 150 points added to his BEST BUY account managed by MBNA because he made a $150 purchase transaction at BEST BUY with his credit card or other token. Likewise, when User A visits another participating merchant such as BLOCKBUSTER, there may be an instruction sent from BLOCKBUSTER to its acquiring bank that User A should have 30 points added to his BLOCKBUSTER account managed by that acquiring bank because he made a $30 purchase transaction at BLOCKBUSTER with his credit card or other token.

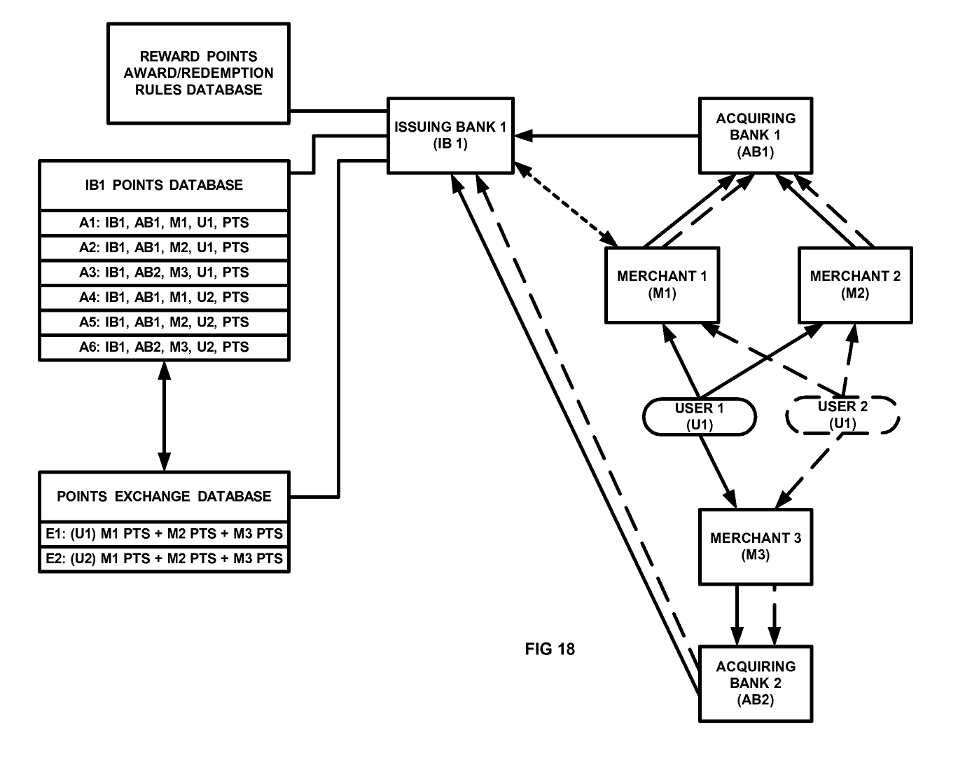

Furthermore, in the issuing bank embodiment, the maintaining of these merchant loyalty points may be undertaken by storing user and merchant account information in a database associated with the issuing bank as shown in FIG. 18. Thus, FIG. 18 illustrates a simple database format wherein each merchant and user under that merchant has a record which indicates how many points are in the account, as well as other optional information (such as par value of points, restriction on use, etc.) The format of the storage of the information is unimportant and may take many forms as well know in the art of relational and other types of databases. A simple transaction log may keep information on each transaction processed; this log may be easily modified to include reward point information as well. Thus, there may be a setup fee charged by the issuing bank to initiate the loyalty reward program for a merchant, as well as transaction fees that provide for a small percentage of revenue to the issuing bank for each transaction.

Although this issuing bank embodiment contemplates utilizing the already existing relationships between a merchant and its acquiring bank, and then the acquiring bank with the issuing bank, an alternative embodiment will allow the merchant to communicate directly with the issuing bank via the network. That is, a merchant may seek approval of (and payment for) a credit card transaction directly with an issuing bank, as shown by the dotted line in FIG. 18. In either case, purchase transaction information that will enable the issuing bank to add reward points to a merchant reward point account associated with the merchant and a user, will be provided by the merchant to the issuing bank, either via the acquiring bank (or another third party involved in the transaction) or directly.

The issuing bank may set up the accounts with each merchant as desired. That is, an issuing bank such as MBNA may agree with a merchant such as BEST BUY that every time a user of MBNA's credit cards purchases an item at BEST BUY, MBNA will allow for a reward point account to be opened and increased for that particular user and for BESY BUY transactions only. In one case, there may be a requirement that a specific instruction be sent from BEST BUY to MBNA (typically as part of the credit card transaction) in order for points to be awarded. Thus, there would be an instruction from BEST BUY to MBNA that User A should have 150 points added to his BEST BUY account managed by MBNA because he made a $150 purchase transaction at BEST BUY with his MBNA card. Likewise, when User A visits another participating merchant such as BLOCKBUSTER, there may be an instruction sent from BLOCKBUSTER to MBNA that User A should have 30 points added to his BLOCKBUSTER account managed by MBNA because he made a $30 purchase transaction at BLOCKBUSTER with his MBNA card.

In another case, there may be predetermined rules established and stored in a reward rules database, for example, at the acquiring bank as shown in FIG. 14 or in the issuing bank embodiment as shown in FIG. 18. These reward rules would control the issuance of reward points to certain users by certain merchants under certain conditions, as set forth in the rules. For example, a rule may be established that would provide for all users to obtain reward points from a merchant based on the particular item purchased by a user (e.g. all users would receive 25 reward points for purchasing a DVD, or all users would receive reward points equivalent to the purchase price for purchasing a particular brand of stereo equipment, etc.) In addition, a rule may be established wherein users would receive reward points from a merchant based on the purchase price of an item (e.g. all purchases over $30 are eligible for points). Also, a rule may be established wherein users are awarded points by merchants only in certain geographic locations (e.g. all BURGER KING outlets in Manhattan are awarding points). Another rule would provide for reward points to be awarded only on certain days or dates, and/or only at certain times of the day (e.g. reward points awarded by STARBUCKS only on weekend during morning hours).

In the case of a rules-based award scenario, specific instructions need not be given for each transaction by the merchant to the acquiring bank (or the issuing bank) to provide reward points to the user. Rather, the acquiring bank (or the issuing bank) will have information provided from the merchant and/or other sources as part of the purchase transaction (such as item purchase, purchase price, location of merchant, and day/date/time of purchase), and will refer to the rules database to determine if reward points should be awarded. In addition to storing the reward rules database at the issuing bank, the reward rules database may be located at a merchant site, or at any intermediary or associated site such as an acquiring bank or an issuing bank.

The user will be able to view all of his reward point account balances by either a paper statement and/or a web site. Since a credit card user receives a statement every month that lists his purchases, amounts due, etc., it is efficient to add to the statement a list of all of his reward point accounts, for example as follows:

| | |
|---|---|
| BLOCKBUSTER | 250 points |
| BEST BUY | 695 points |
| TONY'S PIZZA | 110 points |
| 7-11 | 39 points |
| SHELL GASOLINE | 225 points |

The user may also be able to view his loyalty point account balance for a given merchant by logging into a web site run by the central server (in the central server embodiment) or the acquiring bank (in the acquiring bank embodiment) or the issuing bank (in the issuing bank embodiment) for that merchant. Optionally, the merchant may have a link on its web site so that the user can check his account, or there may be a redirection from the merchant site to the acquiring bank web site, etc. The user may also be able to place a telephone call and, using well known techniques for acquiring information via DTMF tones or audible instructions, obtain account information. The purchaser need not even know that the account is being held for him by the central server (or the acquiring bank server or the issuing bank server) since it will operate in the “back office” aspect of this invention, thus rendering the specific procedures transparent to the user and providing a great ease of use of the system.

Thus, a purchaser may build up many similar loyalty reward accounts simply by using his credit card for making purchases as he has done so in the past. With respect to the acquiring bank embodiment, since all credit card transactions at any merchant must be processed by the acquiring bank for that merchant, then all of the merchant's reward point accounts—regardless of the user involved—will reside with the same acquiring bank. Likewise, with respect to the issuing bank embodiment, since all credit card transactions at any merchant must be processed by the issuing bank that issued the credit card, then all of the user's reward point accounts—regardless of the merchant involved—will reside with the same issuing bank. The system may be configured to not even require a separate “frequent use” account number to be entered at the POS, since this is many times cumbersome for a user. Experience teaches that many users do not even bother with obtaining frequent use or loyalty points (i.e. from major entities such as Hilton Hotels) since the time and effort in opening a separate account, remembering the account number or carrying a separate membership card, remembering their PIN, etc. is simply unmanageable. The system may simply tie in the loyalty account data to the user's credit card number and a merchant ID setup for each merchant.

Although some issuing banks have their own reward point program (such as MBNA's MASTERCARD), these programs award points to a user based on their credit card use at a merchant, but the loyalty reward program inures solely to the benefit of the issuing bank, and not the merchants themselves. That is, a user gets “MBNA points” and obtains the account information on his MBNA statement, but there is no branding or loyalty based on a transaction with a given merchant as in the present invention. Moreover, the present invention provides for redemption of points and aggregation of points in a manner not possible with a prior art issuing bank loyalty program (the items that can be obtained with issuing bank points are quite limited and often render the benefits meaningless).

Under this invention, each purchaser/cardholder enjoys the benefits of being an independent account holder, earning loyalty reward points with every merchant that elects to participate under the system. Likewise, each cardholder may execute a transaction wherein points are purchased from an issuing bank or a merchant, at a discount rate that will provide transaction fees for the points issuer/distributor accordingly. The purchased points may be redeemed, or they may be given to others as a gift, or sold to others, etc. The points have a par value that may increase or decrease. The system may be configured so that there are no restrictions on their transfer (i.e. so that they are fungible and fully transferable).

In any event, a merchant's reward points may be made to be interchangeable with an issuing bank's branded points. Thus, a holder of BEST BUY points may also use any reward points he has independently accrued on his credit card loyalty account (e.g. MBNA Mastercard) to purchase items at BEST BUY.

As previously mentioned, rules may be established with respect to all parties involved—the merchants, the issuing banks, the acquiring banks, and the credit card network operator—regarding earning, aggregating and redeeming loyalty points, which will provide a completely customizable and fluid loyalty point system using an existing credit card network infrastructure.

Although the present invention has been described with respect to the use of a credit card, the invention will operate in the same manner with the use of debit cards or check cards that are becoming popular today. That is, the methodologies employed do not vary significantly when a debit card is used (except that the purchaser's account is debited immediately by the issuing bank rather than billing the purchaser later on) rather than a credit card. The present invention includes the use of such debit cards modified as may be required to operate with the same advantages as herein described.

Likewise, the present invention may be advantageously adapted to provide merchant-based loyalty reward points based on cash transactions as well as the aforementioned credit card and debit card transactions. Cash transactions still make up a substantial portion of purchases, and it would be beneficial for a merchant to provide loyalty points to purchasers using cash in addition to those using credit or debit cards. This will further increase loyalty to that merchant. In this case, the purchaser would still have to present some identification such as his credit card (if the credit card number is being used for unique identification of the purchaser and indicating his loyalty account with the central server). Thus, for example, if a purchaser pays $50 in cash for an item at a store and presents his credit card, the credit card may be swiped at the POS for the sole purpose of awarding him 50 reward points at the acquiring bank server (or the issuing bank server in the issuing bank embodiment).

In situations where a customer may not be creditworthy, or simply may not want to have any credit cards or debit cards, a “dummy” card may be used as the token that takes the shape and form of a credit card, along with branding by the issuer, and which may have the logo of the credit card network imprinted thereon, but which is not tied to a credit account or a debit account of the user. The card is used to link the user to a reward points account in the same manner that an actual credit or debit card is linked. (In addition, when the user wishes to redeem his loyalty reward points, the points may be utilized for a purchase by presenting the card and swiping it into the POS terminal in a manner similar to a credit card presentation.)

In the present invention, reward points accounts for a user shopping at a merchant may be opened and awarded automatically, or the system may require an enrollment process by the merchant, in which the merchant has the opportunity to capture relevant demographic and other data regarding the users.

Once the purchaser has earned loyalty points with this invention, he or she may choose to redeem his loyalty points in any one of various manners. In one embodiment, the purchaser will execute a purchase transaction with the merchant directly, and indicate that he wishes to utilize his loyalty points to pay for the item in full or in part. For example, the purchaser may want to use 5,000 of his Smith Pizzeria reward points (worth one cent per point) to reduce the purchase price of a meal for his family from $75 to $25. He indicates this to the merchant at the point of sale (which may be over a web site or physically at the restaurant). In the event that he presents his credit card to make his partial payment, then the same approval process takes place as described above. In addition, the purchaser's loyalty account (which is stored at the central server in the first embodiment, at the acquiring bank server in the second embodiment, or at the issuing bank server in the third embodiment) is reduced by the number of designated points (i.e. 5,000 points). This is easily done in any of these embodiments since the central server is tied into the credit card network and can be easily accessed by the acquiring and issuing banks. The merchant issues an instruction to reduce the loyalty account accordingly. In this case, the issuing bank will pay the acquiring bank $25, and the acquiring bank will pay the merchant $25 and cause the central server (or the issuing bank server or the acquiring bank server, as the case may be) to reduce the appropriate loyalty point account by 5,000 points (the discounts mentioned above will be also taken by the member banks). As a result, the Smith Pizzeria has now provided a very powerful loyalty scheme without any significant investment in infrastructure that would be required had it not used the infrastructure of the member banks of the credit card network. By paying a modest transaction fee (i.e. a chargeback), the merchant has gained significant loyalty power that was heretofore unavailable.

Referring to FIG. 14, an example of the second embodiment, wherein the reward point accounts are maintained at the acquiring bank, will now be described. In this simplified scenario, user 1 (U1) purchases products at merchant 1 (M1), merchant 2 (M2), and merchant 3 (M3). Both M1 and M2 happen to use the same acquiring bank 1 (AB1) for processing their credit card transactions. Merchant 3 (M3) uses a different acquiring bank 2 (AB2). As a result of the purchases AB1 and AB2 must transact with issuing bank 1 (IB1), which issued U1's credit card. As a result of his transactions with M1, U1's “M1 Loyalty Points” are stored in account 1 (A1) at AB1. As a result of his transactions with M2, U1's “M2 Loyalty Points” are stored in account 2 (A2) at AB1. And, as a result of his transactions with M3, U1's “M3 Loyalty Points” are stored at AB2 (not shown).

User 2 (U2) also has a credit card issued by IB1, and his transactions with M1, M2 and M3 yield “M1 Loyalty Points” at account 4 (A4) at AB1, “M2 Loyalty Points” at account 5 (A5) at AB1, and “M3 Loyalty Points” at AB2 (not shown).

Each of these accounts A1-A6 represents separate loyalty accounts that U1 and U2 have with each of these merchants individually. For example, A1 may represent U1's loyalty points with BEST BUY; A2 may be his loyalty points with CIRCUIT CITY, and A3 may be his loyalty points with BLOCKBUSTER, all of which were earned as a result of purchase at those merchants with the credit card issued by IB1. U1 and U2 may utilize these loyalty accounts separately for redemption at those or other related merchants, as described below. Either user may aggregate or combine their loyalty reward points into an exchange account for increased purchasing power, also as described below.

Once the purchaser has earned reward points with this second embodiment of the invention, he or she may choose to redeem his points in any one of various manners. In one embodiment, the user U1 will execute a redemption purchase transaction with the merchant M1 directly, and indicate that he wishes to utilize his reward points from account A1 to pay for the item in full or in part. For example, the purchaser may want to use 5,000 of his BEST BUY reward points from A1 (worth one cent per point) to reduce the purchase price of an electronics product from $75 to $25. He indicates this to the BEST BUY merchant M1 at the point of sale (which may be over a web site or physically at the store). In the event that he presents his credit card to make his partial payment, then the same approval process takes place as described above. In addition, the purchaser's loyalty account A1 at the merchant's acquiring bank AB1 is reduced by the number of designated points (i.e. 5,000 points). The merchant M1 issues an instruction to the acquiring bank AB1 to reduce the loyalty account A1 accordingly. In this case, the acquiring bank will request approval only of the difference between the redemption purchase price and discount due to the redemption of reward points (i.e. $25 in our example above); the issuing bank IB1 will pay the acquiring bank AB1 $25, and the acquiring bank AB1 will pay the merchant M1 $25 and the acquiring bank AB1 will reduce the appropriate reward point account A1 by 5,000 points (the discounts mentioned above will be also taken by the member banks). As a result, BEST BUY has now provided a very powerful loyalty scheme without any significant investment in infrastructure that would be required had it not used the infrastructure of the member banks of the credit card network. By paying a modest transaction fee (i.e. a chargeback), the merchant has gained significant loyalty power that was heretofore unavailable.

Similarly, referring to FIG. 18, an example of the third embodiment, wherein the reward point accounts are maintained at the issuing bank, will now be described. In this simplified scenario, user 1 (U1) purchases products at merchant 1 (M1), merchant 2 (M2), and merchant 3 (M3). Both M1 and M2 happen to use the same acquiring bank 1 (AB1) for processing their credit card transactions. Merchant 3 (M3) uses a different acquiring bank 2 (AB2). As a result of the purchases AB1 and AB2 must transact with issuing bank 1 (IB1), which issued U1's credit card. As a result of his transactions with M1, U1's “M1 Loyalty Points” are stored in account 1 (A1). As a result of his transactions with M2, U1's “M2 Loyalty Points” are stored in account 2 (A2). And, as a result of his transactions with M3, U1's “M3 Loyalty Points” are stored in account 3 (A3).

User 2 (U2) also has a credit card issued by IB1, and his transactions with M1, M2 and M3 yield “M1 Loyalty Points” at account 4 (A4), “M2 Loyalty Points” at account 5 (A5), and “M3 Loyalty Points” at account 6 (A6). These accounts are also shown in the IB1 Points Database stored in association with IB1.

Each of these accounts A1-A6 represents separate loyalty accounts that U1 and U2 have with each of these merchants individually. For example, A1 may represent U1's loyalty points with BEST BUY; A2 may be his loyalty points with CIRCUIT CITY, and A3 may be his loyalty points with BLOCKBUSTER, all of which were earned as a result of purchase at those merchants with the credit card issued by IB1. U1 and U2 may utilize these loyalty accounts separately for redemption at those or other related merchants, as described below. Either user may aggregate or combine their loyalty reward points into an exchange account for increased purchasing power, also as described below.

Once the purchaser has earned reward points with this third embodiment of this invention, he or she may choose to redeem his points in any one of various manners. In one embodiment, the user U1 will execute a redemption purchase transaction with the merchant M1 directly, and indicate that he wishes to utilize his reward points from account A1 to pay for the item in full or in part. For example, the purchaser may want to use 5,000 of his BEST BUY reward points from A1 (worth one cent per point) to reduce the purchase price of an electronics product from $75 to $25. He indicates this to the BEST BUY merchant M1 at the point of sale (which may be over a web site or physically at the store). In the event that he presents his credit card to make his partial payment, then the same approval process takes place as described above. In addition, the purchaser's loyalty account A1 at the issuing bank is reduced by the number of designated points (i.e. 5,000 points). The merchant M1 issues an instruction to the issuing bank IB1 (via the acquiring bank AB1) to reduce the loyalty account A1 accordingly. In this case, the issuing bank IB1 will pay the acquiring bank AB1 $25, and the acquiring bank AB1 will pay the merchant M1 $25 and the issuing bank IB1 will reduce the appropriate loyalty point account A1 by 5,000 points (the discounts mentioned above will be also taken by the member banks). As a result, BEST BUY has now provided a very powerful loyalty scheme without any significant investment in infrastructure that would be required had it not used the infrastructure of the member banks of the credit card network. By paying a modest transaction fee (i.e. a chargeback), the merchant has gained significant loyalty power that was heretofore unavailable.

In addition to using a reward point redemption instruction from the merchant to the acquiring bank (or to the issuing bank), a set of redemption rules may be put in place, similar to those described above with respect to points automatically awarded for purchase transactions. Thus, these redemption rules would control the redemption of reward points by certain users at certain merchants under certain conditions, as set forth in the redemption rules. For example, a rule may be established that would provide for all users to redeem reward points with a merchant based on the particular item purchased by a user. In addition, a rule may be established wherein users would redeem reward points with a merchant based on the purchase price of an item. Also, a rule may be established wherein users redeem points with merchants only in certain geographic locations. Another rule would provide for reward points to be redeemed only on certain days or dates, and/or only at certain times of the day.

Reward point issuance and redemption may occur physically at a point of sale, such as a store location, or it may occur online as part of an online purchase transaction. In the case of a physical store, the user would present the token, which in the preferred embodiment is the credit card, to have the merchant award (or redeem) points to his account as identified by the credit card number. Other tokens may be used, such as debit cards, loyalty cards, smart cards, stored value cards, etc. As long as the token has a unique identification number associated with it, that number may be used to identify the user. This of course may be done online as well with methods well known in the art, such as by entering a credit card number as part of a purchase transaction over the Internet. In addition, intangible tokens may be used, such as a user's social security number or a predefined PIN. In the event that the user does not have a credit card, and his SSN is used, then the issuing bank may link the user to his reward account by the SSN (or other PIN) even though a credit transaction does not occur.

Optionally, the system may be configured to provide that merchants may be reward points issuers only (without point redemption), or they may be reward points redeemers only (without point issuance). In the case wherein a merchant elects to be only a point redeemer, rules will be established and stored that will indicate from which other merchant loyalty accounts that merchant will accept and redeem points. When merchant A chooses to accept points that were originally issued by merchant B, then merchant B will provide consideration, via the system, to merchant A as a result of the redemption. Merchant A may only receive a percentage (e.g. 90%) of the purchase price, with the discount being held by the system as a transaction fee. For example, when merchant A sells a product to a purchaser that costs $10, and the purchaser elects to redeem points for the purchase, he must redeem 1,000 points (at one cent per point) that were issued by merchant B. Merchant B will pay $10 into the system in exchange for retiring the points, and merchant A will receive $9 in payment for the item purchased. Merchant B will have acquired a customer, and made an incremental profit on the sale, that it would otherwise not have made if it did not act as a point redeemer under this invention. In the event that merchant A becomes a point issuer as well as a point redeemer, then the discount may decrease to 5%—so that the same transaction as above will result in the merchant A receiving $9.50 rather than $9.00.

In situations where a purchaser attempts to redeem points at a store for the first time (i.e. with that were obtained from a different issuer merchant), the redeeming merchant may elect to provide a bonus opportunity for that purchaser as a reward for using that merchant for redemption. For example, the merchant may provide that the points have an increased value for that particular redemption, or it may provide a purchase price discount, etc.

In addition to redeeming reward points directly with the merchant that awarded the points, the user/purchaser may aggregate reward points from more than one merchant loyalty reward point account to increase his purchasing power. That is, he may have dozens or even hundreds of similar reward accounts with the various merchants with which he does business; such as hardware stores, movie theaters, car washes, video rental stores, gas stations, hotels, airlines, etc. Since any type of merchant that accepts his credit card (or other loyalty token) is empowered with a custom-tailored loyalty program under this invention, there is virtually no limit to the number and type of merchant loyalty accounts that a user may have under this invention.

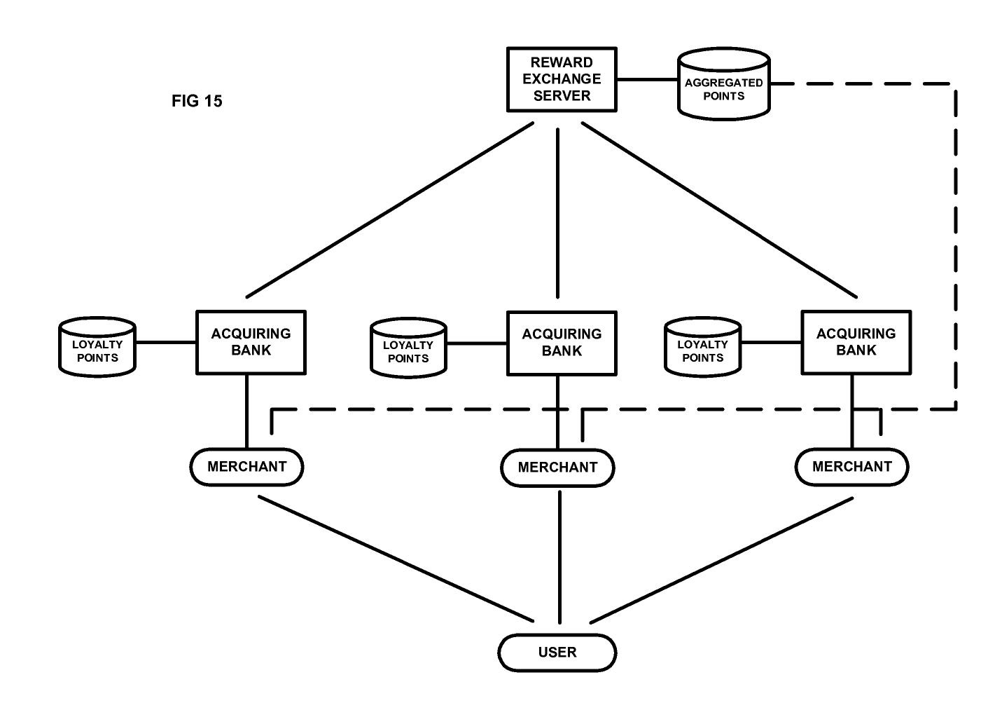

Loyalty points aggregation is undertaken by an exchange server database, which may be located with any entity on the network including the central server, the issuing bank server, or the acquiring bank server (or external to the network and operating on behalf of the network members, as shown in FIG. 15). The reward point exchange server allows a user to view his loyalty points portfolio easily (such as on a web page or in a printed document mailed to the user periodically, e.g. the billing statement), it allows the user to manage the exchange and aggregation of reward points from any of his individual merchant accounts into his reward point exchange account, and it allows the user to execute redemption purchase transactions with his aggregated reward points. For example, if an exchange account is held by an issuing bank, then user U1 may establish a reward point exchange account E1 with his issuing bank (such as CITIBANK) directly, and CITIBANK will use his account number (with appropriate security procedures) to determine all of the reward database records and accounts stored on the various acquiring (and/or issuing) banks on the network. User U1 will not need to enter dozens or even hundreds of account numbers, since his loyalty reward accounts will be tied directly to his credit card number. Once the reward point exchange server obtains his reward points information from the separate merchant accounts, it will generate a web page to display the account totals to the user. The user can then instruct the reward point exchange server to aggregate reward points into his reward point exchange account from selected merchant accounts as desired. Consideration may be provided from the merchant to the reward point exchange server that correlates to the number of points exchanged. So, for example, if the user requests that 5,000 points be transferred from his BEST BUY merchant reward account A1 to his reward point exchange account E1, then the BEST BUY account A1 will be reduced by 5,000 points. The BEST BUY acquiring bank will invoice the merchant by the reduced amount, which may for example be $30. The user U1 will no longer be able to obtain a direct loyalty discount for those points with the merchant M1 since he has exchanged them into his reward point exchange account E1. (He may still be able to redeem his exchange points from E1 with that merchant M1 as part of a cluster or network-based transaction, described below).

In the central server embodiment, aggregation of reward points by an exchange server also allows a user to use different credit cards with the same merchant and combine the points in one purchase. That is, in the event that a purchaser uses more than one credit card at different times to make his purchases at a merchant, then his loyalty points will be stored on different accounts at the central server. The purchaser can later aggregate those points by the exchange server into one account, by indicating the different credit card numbers to the exchange server and instructing the exchange server to aggregate the points from the various accounts on the central server. This may be done for groups of cards such as when various family members hold cards on the same account. It is noted that the user may optionally be able to use the different credit cards at a POS with the merchant and obtain loyalty point redemption directly for the different accounts at the merchant with needing to use the exchange server.

When the purchaser utilizes the reward points exchange server for aggregating his or her loyalty reward points from various merchants, exchange rates may be set wherein the purchaser loses some points or value as a transaction fee based on the exchange. So, for example, the purchaser may only net 3,000 exchange points for the above transaction in which 5,000 merchant points are exchanged. The actual exchange rate and fee structure may be set amongst the merchants, the acquiring bank and/or issuing bank and the reward points exchange server operator in order to provide a fair compensation scheme for each party while maintaining the benefits of the system, including the building of merchant loyalty and the ability of the consumer to use his reward points in ways heretofore unavailable.

The purchaser may repeat this type of transaction with any or all of his accounts and aggregate them into his reward points exchange account for the purpose of purchasing an item that he may otherwise be unable to obtain with the points aggregation. For example, he may aggregate 3,000 points from one account, 7,000 from another account, and 10,000 points from another to provide a total of 20,000 exchange points in his reward points exchange account. Although the system greatly advantages mid-sized and smaller merchants that have no independent loyalty programs, the consumer may also be able to exchange points from outside the network; i.e. from airlines or hotel chains, into his reward points exchange account.

After the purchaser has aggregated his desired points, he may execute a redemption purchase transaction with those points. In the preferred embodiment, the purchaser may purchase any item at any merchant that accepts his credit card—which will be virtually every merchant. The aggregated loyalty reward points will reduce the purchase price by the number of points surrendered by the purchaser for that transaction. In this case, the merchant may be required to pay a small transaction fee to cover the administrative cost of utilizing aggregated reward points under the invention. The purchaser may pay for all or part of the purchase with aggregated reward points. When the purchaser executes the redemption purchase transaction, the number of designated reward points is taken from the reward points exchange account, and corresponding consideration is transferred to the appropriate merchant (minus a transaction fee). As an option, the transaction fee for a merchant may be lessened or even waived if the purchase is made with loyalty reward points issued by that merchant (as opposed to loyalty reward points from another merchant).

The present invention allows for a transaction executed with reward points to bypass the acquiring and issuing banks and proceed directly with the reward points exchange server, assuming that the user has enough aggregated reward points in his reward points exchange account. In the event that part of the redemption purchase must be made with the credit card, then payment of the balance would be redirected to the acquiring bank and issuing bank as done in the prior art for regular purchases.

In an alternative embodiment, the purchaser may select an item from a catalog of items provided in conjunction with the reward points exchange account. For example, CITIBANK may partner with an entity or entities that can provide to it a catalog of items for sale. The purchaser can easily link to that catalog and make a redemption purchase accordingly.

As previously noted, an issuing bank may fill the role of the reward points exchange server (notably in the issuing bank embodiment since it holds all of the user's merchant-sponsored reward point accounts). Once the points have been aggregated by the purchaser, he may make a redemption purchase transaction with any merchant that will accept his credit card. He can indicate that he is making the purchase with aggregated reward points only, with reward points and credit, etc. This may be done easily over a web site if it is an e-commerce transaction, or it may be done at the physical point of sale. In the alternative, the purchaser may simply choose to pay full price at the POS and then reduce his bill from the issuing bank by a corresponding amount of aggregated reward points.

The system of the present invention may be adapted so that the reward points exchange service is located on any computer either within the credit card network or external to the network. As described more fully below, the exchange server needs to be in communication with the computers that store the individual reward points accounts, in order for points aggregation to occur as explained herein. In a preferred embodiment, the purchaser/user is given access to the reward point exchange server, such as by a web page over the Internet, to allow him or her to view the loyalty point account information, aggregated point information, and to effect aggregation of points from one or more individual reward point accounts into the points exchange account as desired.

In one aspect of the invention, the merchant is the entity that essentially funds the administrative costs and overhead of the loyalty program. Thus, the merchant has acquired entry into a powerful loyalty program and robust customer acquisition program in exchange for paying nominal transaction fees on points issuance and/or aggregation and/or redemption against the incremental revenue gained due to the loyalty program. Unlike a network-funded loyalty system, which provides nominal incentives and is highly restrictive with no meaningful awards obtainable, the present invention eliminates restrictions if desired and provides a broad-based points issuance, aggregation and redemption network.

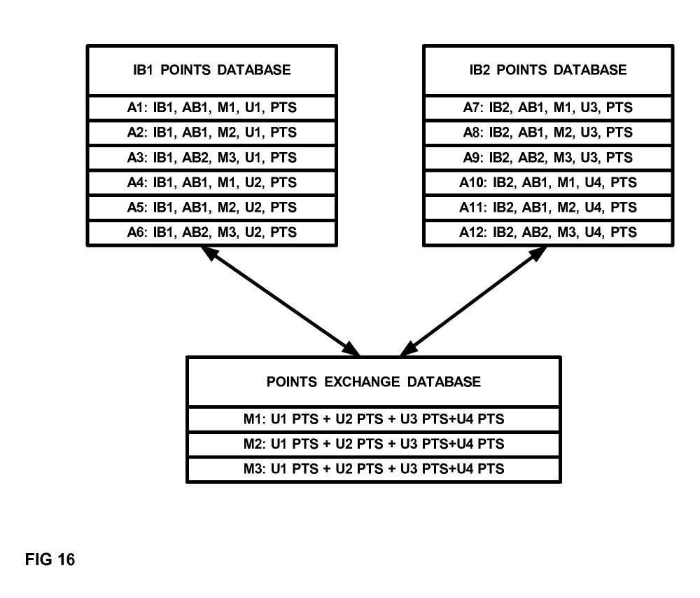

As a result of providing loyalty points to different users who may have credit cards issued by different issuing banks, a merchant will have loyalty points accounts stored in various issuing banks. A points exchange database may also be employed by any member bank (or a network operator or third party) that allows a merchant to view his total points that have been awarded to various users at various issuing banks. Thus, merchant bank can monitor and be aware of his outstanding loyalty points even though they may exist amongst numerous issuing banks. FIG. 16 illustrates this concept, wherein two issuing banks IB1 and IB2 have their points databases as shown. A points log is kept at points exchange database (even though the points have not actually been exchanged). Thus, M1 can determine the total number of points by viewing accounts A1, A4, A7, and A10 (corresponding to users U1, U2, U3, and U4).

It is known in the prior art that a debit card may be used to access a user's account to make a purchase in one of two ways; either by a PIN based transaction or by a signature based transaction. Under this invention, a reward point account may be opened and tracked (for awarding as well as redeeming points) for each of these two types of transactions so that a user may have two reward point accounts with a given merchant accordingly. The user may aggregate reward points from these accounts, either into each other or into an exchange account as described above, if desired.

In a further aspect of this invention, a methodology referred to herein as cluster marketing is employed. A cluster may be defined by a group of partner merchants that are related in virtually any manner as defined by the cluster. For example, an entertainment cluster may be defined by a pizzeria, a video rental store, an ice cream shop, a movie theater, and a music store. The cluster may exist in a given geographic location such as a strip mall, a town, or it may be extended into larger regions or across the country, etc. Once a cluster is defined, each member will award their own branded loyalty reward points as described above (or branded with the cluster itself, if desired), and the acquiring bank (or issuing bank) server for each cluster partner will maintain user reward accounts based on purchases made by a user with his credit card at that location.

Agreements will exist between the cluster members that will define, via a set of rules stored in a database in the system, how points may be awarded and/or redeemed by members within the cluster. For example, cluster members may simply agree to honor each other's reward points at redemption. In this case, cluster member A will award its own loyalty points, and cluster member B will award its own loyalty points. When a user makes a purchase at cluster member B, he may redeem his cluster member A points as well as his cluster member B points. Each merchant in a cluster will have access to the reward point records of every other member in the cluster for this purpose (i.e. through the credit card network or a central exchange server). If he tries to redeem points at cluster member A or B that were issued by a merchant that is not a member of that cluster, he would be denied redemption. For example, a pizzeria, ice cream shop, and video store located in the same strip mall may agree to form a cluster and redeem each other's reward points, but no one else's reward points. This rule would be generated and stored in the database so that the system could check to see if an attempted redemption is allowed by the rule. This will provide an incentive to users to shop at these merchants in the same strip mall since they can use reward points at any such merchant, rather than going to a different merchant in a different mall where points would not be interchangeable at redemption. These cluster rules could be easily modified as desired as merchants enter and exit the cluster.

A reward points exchange account relevant to the cluster may also be created for each user and maintained by the credit card network, an independent entity, an acquiring bank, or an issuing bank as described above. In this embodiment, only loyalty reward points from cluster partners may be aggregated with each other into the reward points exchange server aggregation account. Thus, the user may aggregate his loyalty points from his pizzeria account, his ice cream store account, and his movie theater account, since they are partners in the same cluster. They may or may not carry the same par value. He may then make a redemption purchase from any of the cluster partners and utilize his aggregated reward points to pay for the item in whole or in part. (He may also use his reward points from one cluster partner to pay for products from another cluster partner, even if not aggregated on the exchange account, as described above).

By implementing a cluster partner methodology as described, each cluster partner may advertise the existence of the cluster and the partners involved, which will help each partner drive business within the cluster for the purchase of a given product or service. That is, if a consumer is a member of a given cluster, he is more likely to use the products and services of other members of that cluster in order to build his aggregated loyalty reward points quicker than if he used merchants not in that cluster. Thus, although each cluster partner has gained an advantage by offering his own branded loyalty points as previously unavailable in the prior art, each partner has also benefited from the marketing powers of his cluster partners to drive business within the cluster.

As mentioned above, clusters may be defined in any way by the system. A cluster may be defined by business groups such as an attorney cluster. This type of cluster may include merchants commonly used by an attorney, such as an office products supplier, an accountant, a legal research firm, etc. A homemaker cluster may be defined by a supermarket, a dry cleaner, a bank, a florist, and a hairdresser, etc. Likewise, a cluster may be defined by similar merchants across various regions. For example, a limousine cluster may be defined by a group of independent limousine operators across the country (e.g. all services that operate at an airport) so that a traveler may be have incentive to use only those services when he travels, gaining the benefits of increased loyalty points aggregation by using those services.

The system in this embodiment will thus include many clusters, and some merchants may in fact be members of different clusters if permitted by the member agreements. Groups of clusters may also form marketing agreements amongst themselves to allow points aggregation amongst clusters.

A further embodiment of the present invention provides for a merchant that may interoperate with other merchants in the system as follows. Assume that merchant M1 has just registered with the system of the present invention. M1 may log in to the system via a web page adapted for this embodiment, where the merchant M1 may enter parameters indicative of his willingness to honor points that have been issued by another merchant of the system, referred to as MX. For example, M1 may indicate that he is willing to honor or redeem points issued by certain other merchants of the system, or by all other merchants of the system, if desired. He may desire to only redeem points, for example, issued by merchants in his geographic region, or issued merchants who are not competitors of him, or by merchants who are competitors of him, or by merchants in a different geographic region, or by merchants having complimentary products lines, or because customers of one merchant may be the most profitable customers of another merchant, etc.

In any event, merchant M1 may also enter his desired rate of redemption (or discount or premium as described below) with a prospective point issuer merchant. For example, M1 may indicate that he will redeem points at an even rate (1:1) of exchange. In this case, M1 would be redeeming MX's points with the same relative value as MX; so if MX redeems the points he has issued at one cent per point, then a 1:1 rate in this example would means that M1 would give a one cent credit to any customer who redeems points from MX for a given purchase. So, for example, if the customer makes a purchase from M1 and presents his credit card or other token that links to his reward point account(s) as further described herein, then M1 will be informed by the system that the customer has 3,500 points in an account issued by merchant MX. M1 would then offer to honor or redeem the points issued by MX at one cent per point, which would be a credit or discount of $35.00 off of the current purchase. The transaction, if approved by the customer, would then cause the customer's MX reward point account to be decreased by the number of points redeemed (here, all 3500 points would be deducted), and the price would be reduced accordingly (by $35.00). At some point, a settlement would be made between M1 and MX that would cause MX to compensate M1 for this transaction. This may be a payment to M1 in the amount credited ($35), which may be discounted as agreed to by the parties. For example, this transaction might provide a 10% discount wherein MX would pay 90% of the relative value (e.g. $31.50) to M1. M1 considers this discount to be a cost of acquiring business of the customer. Likewise, a premium may be attached, such as a 10% premium, wherein MX would pay 110% of the relative value (e.g. $38.50) to M1. MX considers this to be a cost of eliminating the liability of the reward points of the books. Virtually any arrangement may be made for settlement between the parties depending on market conditions, relative strength of the parties, etc.

Other rates of exchange may be used. For example, assuming the parties agree to a 2:1 rate of exchange, then M1 would redeem the points originally issued by MX at double their value to the customer. So, if the customer would have obtained a $35 credit or discount at MX for redeeming 3,500 points at MX, he would then receive a $70 credit at M1 for redeeming those same 3,500 points with M1. M1 may want to give this increased value to the customer in order to acquire the customer, increase market share, etc. Settlement between M1 and MX would take place as described above, i.e. with discounts, premiums, etc.

This embodiment of the present invention allows for merchants such as M1 to bid for points exchange partners in the following manner. Assume that M1 enters into the system the desired parameters as described above; i.e. desired partner types and a desired rate of redemption and/or settlement term(s). This bid data is entered into the system and communicated to all potential merchant partners in the system that match the criteria input by M1. Other merchants would then accept the offer if desired, reject, or take no action (which would be considered a rejection of the offer). Assuming that one or more of the potential merchant partners accepts the offer, then those trading parameters would be established in the system between M1 and those merchant partners. If no other merchants accept, or some accept but M1 wants to obtain additional partners, then M1 can change his offer terms (e.g. go from a 1:1 exchange rate to a 2:1 exchange rate, or go from a 10% premium to a 15% premium, etc.) and redistribute his bid offers.

This bid/reject/re-offer/accept process is an iterative one wherein the merchant M1 may modify bid offers in accordance with changing market conditions, acceptances or rejections by potential merchant partners, etc. The result of the process is that the merchant M1 will establish a desired number of partner relationships with other merchants (such as in a cluster of merchants) which will benefit all parties involved.

Another aspect of this embodiment is the use of intelligence in the system that can analyze the input criteria provided by the merchant in order to determine suitable partners. For example, the system can look at any or all of the following parameters: annual revenue, market share, market size, products and services offered, rate of points honor/redemption, etc. Potential partner merchants are then determined by the system and offers made to those potential partners in accordance with the criteria input by the merchant M1.

The system will enable the merchants to manage customer profiles, which may be input directly by a merchant or calculated by the system based on criteria. For example, a merchant may input via a web page interface his annual revenue, number of customers, etc. Also, the system may have access to such information via other means, such as by analyzing credit card receipts etc. In any event, each merchant may have a customer profile that may then be matched with other merchants. In the example given above, merchant M1 may input his customer profile (and/or a desired customer profile), and the system may then seek matching profiles from other merchants on order to find appropriate partners for the merchants. As such, the system will be able to match merchants that may want to acquire customers of other merchants with similar or desired customer bases.

The system may also operate in a bulletin board fashion, wherein offers are posted to merchants that may act upon those offers of desired.

This embodiment of the invention provides a promotional currency between reward programs of different merchants that may establish differential values. This embodiment provides a market in advance on points and allows merchants to extract the value of their brand, and gives access to their consumers (those associated with their brand). The program establishes a premium and/or discount value for one program with respect to another program. Also, issuers can control rules and methods by which their programs are traded. This part of the invention establishes relative values between reward programs.

In a further aspect of the invention, the system may operate to include certain types of businesses in an exclusive manner. For example, the system may be adapted to include only one pharmacy chain store, such as WALGREENS, as part of the loyalty network. In this case, WALGREENS would be the only pharmacy store that would issue branded loyalty points that could be aggregated with other loyalty points as described above, both within as well as outside a cluster. The system may also be adapted to allow other smaller pharmacies to operate in the loyalty point scheme if desired.

A merchant may choose to opt out of the system redemption process and accept points only that it previously awarded. Although this invention has been described with respect to a credit card network, other types of networks and infrastructures may be used as well. For example, a global communications network such as the Internet may be used, as well as a wireless network and an interactive television network.

In the alternative to utilizing the acquiring bank for storing individual merchant reward point accounts as well as aggregated reward point accounts, a central server may be used for this function as shown in FIG. 12A. That is, a centralized functionality may be used, such as a credit card network administrator or operator, to perform the functions of the present invention. In this case, the merchant computers and/or the acquiring banks would communicate via the network (or via an external network such as the Internet) with the central server to instruct the central server to store reward points, redeem reward points, and aggregate reward points, in the same manner as with the acquiring bank (and issuing bank) described above. By centralizing the reward point account functions, advantages may be realized such as scalability, economies of scale, etc.

For example, a central server may reside on the credit card network and track the transactions between the merchant, the acquiring bank, and/or the issuing bank. A reward account is maintained on the central server on behalf of the merchant and the user, and the number of reward points in the user's account for that merchant is increased accordingly. There may be a setup fee charged by the central server to initiate the loyalty program for a merchant, as well as transaction fees that provide for a small percentage of revenue to the central server for each transaction made by the central server. Preferably, the user is able to view his loyalty point account balances and aggregate reward points as described above by logging into a web site run by the central server.

In a further embodiment, a third party operates on behalf of an acquiring bank in several aspects, including but not limited to the logging, tracking and storage of reward points on behalf of a merchant and user. In this embodiment, a third party may acquire the business and/or act on behalf of an acquiring bank, in particular by managing and settling transactions between the acquiring bank and other member banks, such as issuing banks. Similarly, the third part may be acting as an intermediary between the acquiring bank and other member banks. As part of its functions performed on behalf of the acquiring bank, the third party sets up reward points accounts in the same manner as the acquiring bank does in the preferred embodiment. Since the third party is managing transactions over the credit card network on behalf of the acquiring bank, the third party will have the information that it needs in order to award and/or redeem reward points for each transaction.

Thus, on request of the acquiring bank, the third party would open an account that logs the reward points that are awarded to a user for a transaction with that merchant as described with respect to the preferred embodiment. This may be a simple instruction filed that is part of the credit card transaction information passed to the third party from the acquiring bank, or it may be a separate instruction, etc. In any event, the third party would keep track of the reward points for that merchant and their customers, adding to the account as purchases are made. In the event that the reward points are requested to be redeemed or aggregated, the third party would interact with the appropriate parties in the same manner as the acquiring bank in the preferred embodiment.

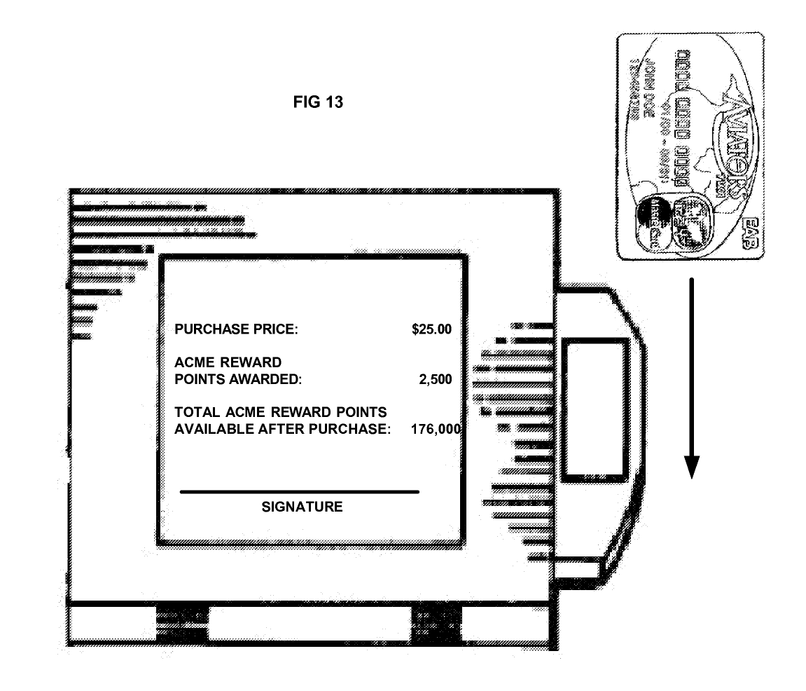

The point of sale (POS) terminal for the present invention will now be described. In the preferred embodiment, the purchaser uses a credit card as a token for accessing the system; i.e. for obtaining reward points for a purchase transaction with a merchant and for redeeming reward points during a redemption purchase transaction with the merchant. When the purchaser visits a physical location such as a store for making a purchase transaction, he will present his credit card as in a regular credit card transaction. In one case, the POS terminal will be located on the counter so that the purchaser can swipe the credit card through the magnetic stripe reader in the open slot, and the POS terminal will read the credit card information, which will identify the issuing bank as well as the account number of the purchaser. An example of this device is shown in FIG. 13. A message will be sent to the merchant's acquiring bank, which will include the credit card information as well as the merchant identification and the amount of the purchase (i.e. the credit requested for authorization). The message may also include an instruction for the acquiring bank to award reward points to the purchaser related to the amount of the purchase, assuming it is approved and executed. For example, the POS may be adapted to instruct the acquiring bank (or issuing bank) to award one point for each dollar in a given transaction, so a $100 purchase would result in the acquiring bank (or issuing bank) logging 100 reward points in the account associated with that merchant and that purchaser, as identified in the message sent to the acquiring bank (or to the issuing bank via the acquiring bank) from the merchant POS terminal.

The POS terminal will have a display (e.g. a touchscreen) that typically shows the purchaser the amount of the purchase, and a line for a signature to be entered by the purchaser once the transaction has been authorized by the issuing bank. The display will also show the purchaser how many points that have been awarded as a result of the transaction, and it may optionally show the total number of points in the purchaser's account with that merchant (in this case, the total would be sent back from the acquiring bank (or issuing bank) to the merchant POS as part of the authorization message). Other information regarding the reward point system may also be displayed, such as “Purchase a CD next weekend and get double points!”, or the like. Optionally, the number of points may also be printed on the receipt that is printed by the POS terminal and given to the purchaser.

In the case where a reward rules-based scenario is implemented to award reward points automatically based on predetermined rules stored in a database (for example at the acquiring bank or issuing bank), then there is no requirement for a specific instruction for awarding reward points to be sent as part of the credit card transaction. As described above, the transaction information (purchase price, item identification, purchaser identification, merchant identification) will be passed on to the acquiring bank (or issuing bank), and the acquiring bank (or issuing bank) will use that information along with the rules database to determine if reward points should be awarded, how many points, etc. based on the rules previously established.

In a further embodiment wherein a cluster of merchants has been formed as described above, the acquiring bank (or issuing bank) may send information regarding some or all of the cluster merchants and the purchaser's respective reward accounts for each merchant, and the POS terminal will display this cluster information similarly to the case above with the single merchant. Thus, for example, the POS terminal display may indicate how many reward points the purchaser has in each of several cluster merchants as follows:

Your BLOCKBUSTER account has 3,750 points

Your CIRCUIT CITY account has 4,654 points

Your FRIENDLY's account has 285 points

This may also be printed on the receipt for convenience of the user.

In the case where the merchant's acquiring bank stores all of the reward accounts for the merchants in the cluster (i.e. all of the merchants in the cluster use the services of the same acquiring bank), then it is relatively straightforward for that acquiring bank to provide all of the merchants' reward point data for that purchaser to the POS terminal for display as described. There may be instances, however, wherein it is desired to display reward point account data from merchants that use a different acquiring bank. In these cases, then the different acquiring banks communicate with each other, such as over the credit card network, to provide the required reward point data to each other for display to the purchaser.

In a further embodiment, the purchaser may have an aggregation exchange account at the acquiring bank (or the issuing bank or elsewhere), and the aggregated reward point totals may be sent to the POS terminal for display and/or printing in addition to the individual reward point accounts. In the case where the acquiring bank does not store the aggregated reward point account, then the acquiring bank may issue a request to the appropriate server to obtain this information accordingly.

When a purchaser wishes to make a redemption transaction, he will present the credit card to the terminal and press a button (or an area of the touchscreen) that will indicate that he wishes to utilize reward points to pay for some or all of the purchase price of the item. Assuming that the purchaser indicated he will pay the entire price with points, the terminal will send an instruction to the acquiring bank indicating this, and assuming that the reward account for that merchant and purchaser has ample points in it, then the account will be reduced by the number of points required for the transaction. The number of points required may either be directly communicated to the acquiring bank (e.g. 4,000 points for a $40 purchase), or there may be a set of redemption rules stored at the acquiring bank that instructs the acquiring bank how many points to use for that purchase. This is similar to the reward rules described above. In any event, the number of points used for the purchase will be displayed and printed, as well as the remaining reward point balance after the transaction is completed.

The purchaser may also be given the option to use only some points for redemption. The purchaser will enter the number of points to be used (e.g. after a reward account total is displayed to him) into the POS terminal, and the terminal will proceed to calculate the adjusted purchase price after the reward points have been accounted for. So, for example, if the user indicates that he wants to redeem 1,500 points to reduce the purchase price from $40.00 to $25.00, then the credit card transaction will proceed in the amount of $25.00.

The POS terminal interface may also be adapted to provide the purchaser the option to effect a purchase transaction with reward points (from the merchant account, a related cluster merchant account, and/or or aggregated points), even if the purchaser had not originally intended for the transaction to be a redemption purchase transaction (i.e. use reward points). In this case, once a purchaser has presented the credit card to the terminal and the acquiring bank is informed from the merchant of the purchase price that is requested to be authorized, the acquiring bank may first look up the reward points for that user that may be available for redemption (e.g. if certain redemption rules are met as explained above) and then inform the merchant terminal of the points available. In the issuing bank embodiment, the acquiring bank will request authorization from the issuing bank and the issuing bank looks up the reward points for that user. The terminal display would then display a message asking the purchaser if he would like to make the purchase with points or a combination of points and other consideration (“You have 24,342 points available for use in this purchase. How many would you like to use?”). The purchaser can elect not to use reward points and instead pay the full purchase price (thus possibly earning him reward points into his account), or he can elect to pay in full with reward points (if enough are available), or he can elect to reduce the purchase price by redeeming some of his points against the purchase price. After the purchaser has made his election, the acquiring bank takes the appropriate steps (i.e. reduce the point account totals, request credit authorization for a reduced price, or a full price, etc.)

In a further embodiment, a smart card may be used as the token with the present invention. A smart card, which has an integrated circuit(s) and associated memory circuits located on the card, as well as input/output contacts, allows for various applications and data to be easily stored, revised, and managed via a smart card terminal. The smart card terminal will be located at a POS as with the credit card terminal described above. In one embodiment, the reward point information obtained by the POS terminal as part of the purchase transaction may be transferred onto the smart card memory so that the purchaser will have updated reward point information stored on the card. That is, when the user enters the smart card into the reader at the merchant POS, the transaction will proceed as described above, and in addition, the smart card terminal will load the reward point account information into the card's memory. The purchaser may then user the smart card at another reader, such as one associated with his personal computer at home, and read out the reward point account information there as well.

This may be used strictly for informational purposes, or it may be used to effect subsequent transactions. For example, in the event that a purchaser has the smart card terminal connected to his PC, he may barter with other entities over the Internet and utilize his points for purchases, trade points, etc. Once his account totals are updated on his card, he can have the updated totals read out the next time he visits the merchant, and the updated totals will be used to revise the account totals at the acquiring bank server accordingly.

In addition to using a credit card or smart card terminal at the merchant's point of sale as described above, it is increasingly popular to implement online purchases, for example with a web site over the Internet. In this case, the user would enter the appropriate credit card number onto a web page (or scan the card with a terminal connected to this PC), and the process would proceed as described above with respect to the merchant POS terminal. Likewise, reward points may be awarded and/or redeemed via telephone as known in the prior art. Other hardware embodiments such as PDA's, cell phones etc. may also be used with the present invention for awarding and redeeming points as described herein.

The present invention enables acquiring banks to setup and manage reward points accounts on behalf of merchants and their customers. This invention provides for new customer acquisition for a bank that operates as both an acquiring bank and an issuing bank, as now described. When a purchaser has registered as part of the loyalty system herein, the acquiring bank will have information regarding his name, address, etc. When the purchaser uses a credit card to make a purchase as part of the loyalty system herein, data is captured regarding the purchaser. That information may be utilized by the acquiring/issuing bank in order to attempt to obtain his credit card business, for example by preparing and sending him a credit card issued by the acquiring/issuing bank. This acts therefore as a new customer acquisition methodology that will enable acquiring/issuing banks to acquire new customers as a result of using the system of the present invention.

In a further embodiment, a user may be able to transfer reward points from one of his merchant accounts to another user's account as a gift (or for some consideration), and that user will enjoy the benefits of those reward points as if he had earned them himself.

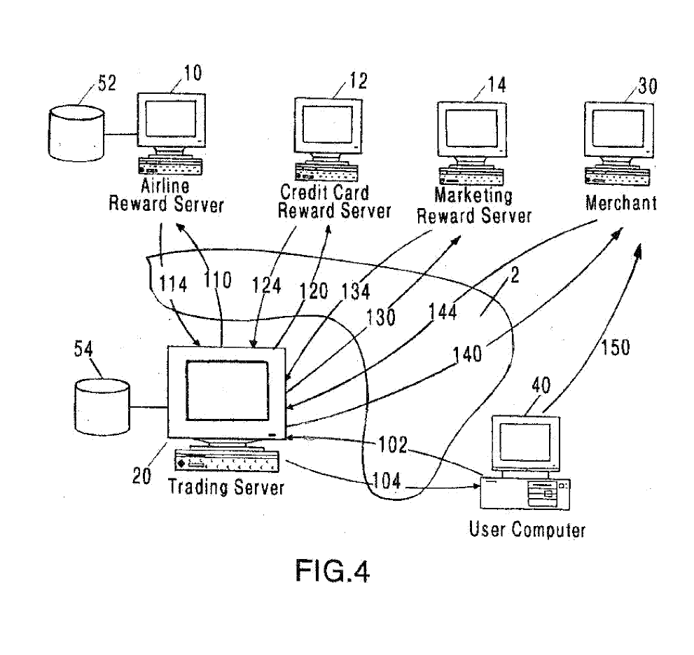

Further details of reward point aggregation will now be described. Reward points aggregation is described in full detail in U.S. Pat. No. 6,594,640, owned by the assignee of the present invention, which is incorporated by reference herein. As described in the '640 patent, and with reference to FIG. 4, a plurality of reward server computers 10, 12, 14, a trading server 20, a merchant computer 30 and a user computer 40 are shown in communication with a network 40. The network may comprise any type of communication process where computers may contact each other. The present invention will be described with respect to an Internet-based network where the reward server computer 10 is associated with an airline frequent flyer program. Any type of reward server may also be used in this system. The reward server computer may be a credit card reward program such as offered by American Express where the user earns rewards based on purchases or an advertising based award program where the user earns rewards by selecting advertising content.

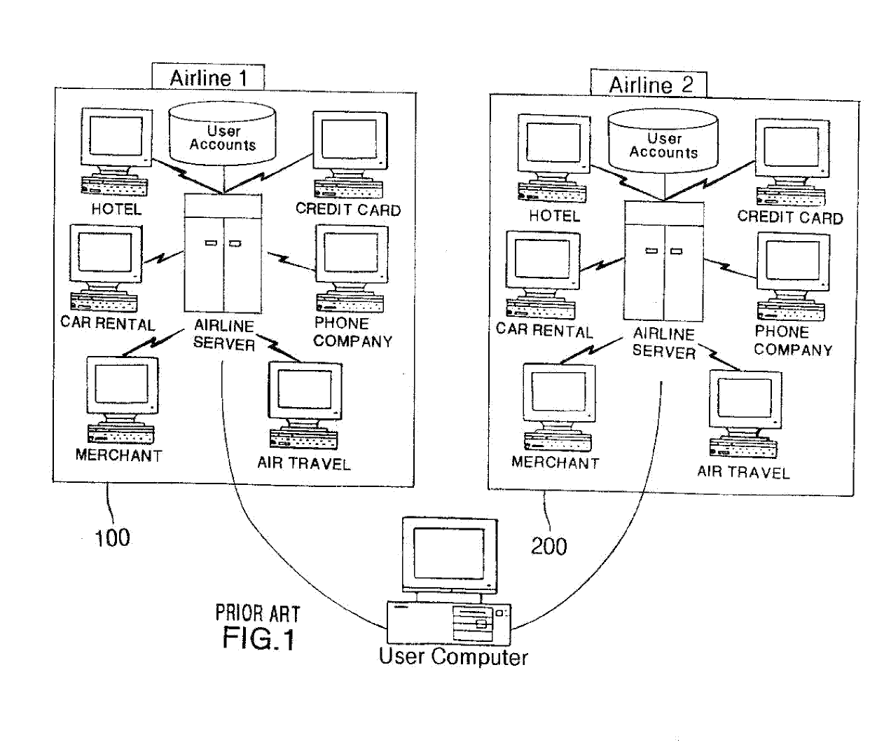

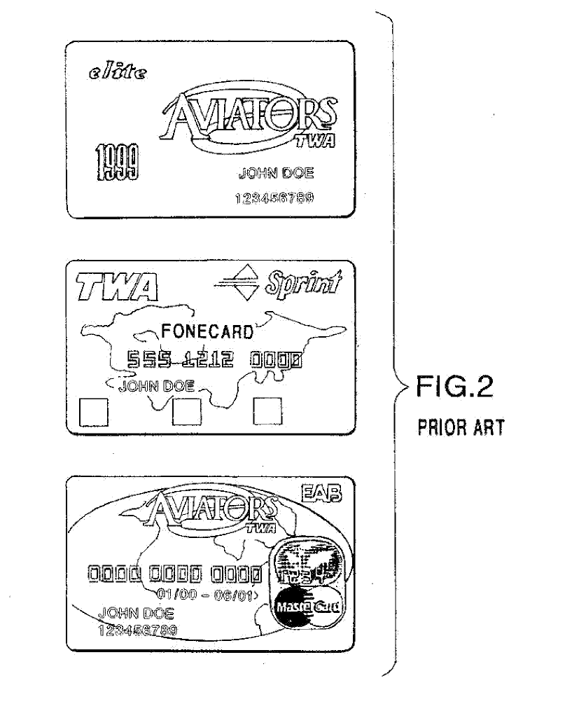

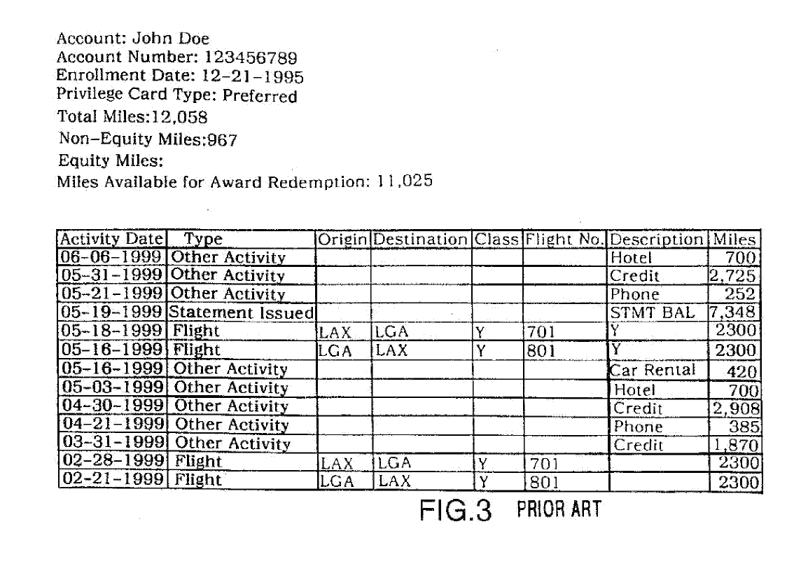

A user of this system may acquire and accumulate rewards through any prior art means such as shown on FIG. 1, which are then posted in a user's reward account 52 that is accessible through the reward server computer 10. The trading server computer 20 is in communication through the network 2 with a user on a user computer 40 and is additionally able to connect to the reward server computers 10, 12, 14 through the network 2 in accordance with techniques well known in the art for Internet communications. The merchant computer 30 is representative of any site that can communicate with the network that has goods or services for sale or trade. The merchant may have a direct relationship with the trading server where the direct relationship allows for a streamlined process for allowing a user to acquire products offered via the merchant computer. Alternatively, the merchant computer may be an independent merchant that does not currently have a profile defined in the trading server that will accept payment from another computer system in any one of well known e-commerce embodiments.

The rewarding entities may be any type of entity that has a service for allocating points or consideration for user actions. The reward server computers 10,12, 14 may be of any type of accessible server capable of holding data about a user along with a corresponding earned value that is negotiable for other goods, services, or points of another system. In the preferred embodiment, the airline reward server computer 10 may refer to one or several different airlines that have frequent flyer programs or the like. The credit card reward server computer 12 may refer to any type and number of credit card server systems capable of holding, increasing or decreasing a user's earned rewards acquired according to the terms of the credit card program to which the user has enrolled. The marketing reward server computer 14 may refer to one or a multitude of network accessible marketing systems that allow a user to have an account where points or other redeemable value may be stored, updated and redeemed by a user. The trading server computer may be any type of computer system that allows users to access the system in order to perform the processes involved in this invention. In the preferred embodiment all of the systems described are accessible through the Internet and the user may freely navigate to any site by means well known in the art.

The present invention allows issuers who originally sold reward points in their program for use as an incentive by third parties to repurchase points at a substantial discount, thereby reducing their liability and allowing for a trading strategy that enables points to continually be sold and repurchased. This may be a separate accounting procedure than what is used for points that are granted.

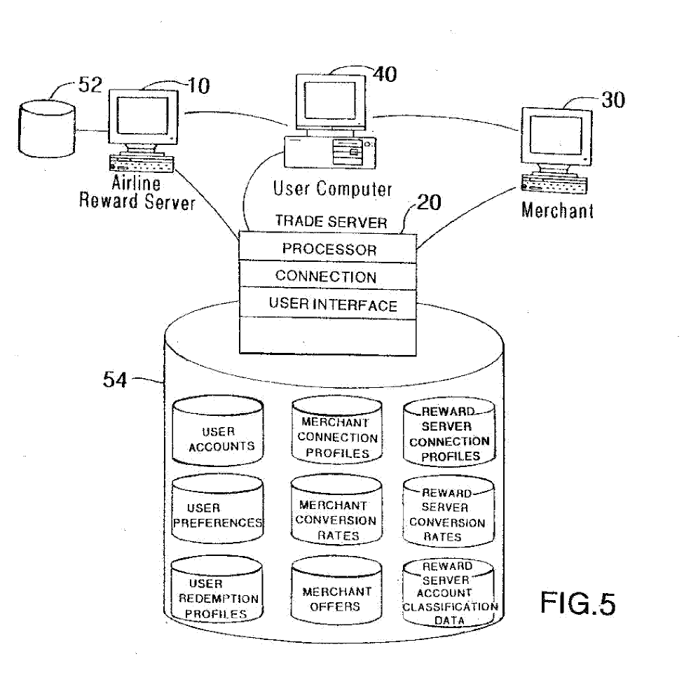

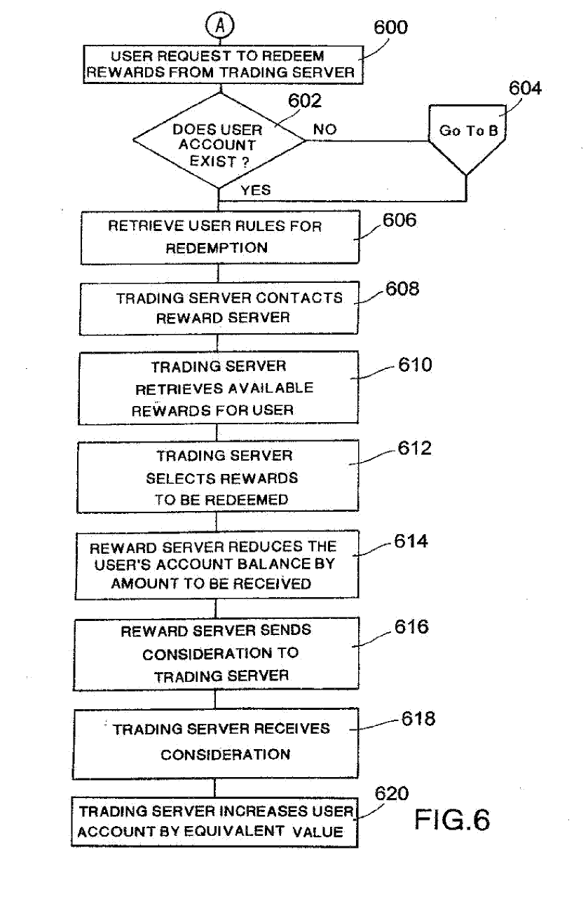

The method of allowing the user to redeem the accumulated reward points from one or more of a plurality of reward entities will now be described with respect to FIG. 4 and the data flow diagram of FIG. 6. The trading server system would allow users to “log in” to access the functionality provided where the user may interact with applications, forms or controls. For example, the user may view his account information by using a web browser to enter the appropriate identification information and then select buttons, links or other selectable objects to navigate to the part of the system desired. The user, from the user computer, makes a request to the trading server computer 20 at step 102, requesting redemption through the network 2 for a portion of the pre-accumulated reward points stored for the user in one of the rewarding entities. A user reward account 52 is associated with each of the reward servers but is only shown in FIG. 4 connected to the airline server for sake of clarity. The user may interactively select rewards to be redeemed, or the system may determine which rewards are to be redeemed based on a previously defined user profile rule. The trading server computer 20 “obtains” the reward points from a reward server 10, 12, 14 stored in the user's account 52 by contacting the appropriate reward server at step 110 according to the user's requirements, by using the connection parameters as defined in a database 54 on the trading server as shown in FIG. 5. In one embodiment, the trading server retrieves reward account balance information at step 114 from the reward server for the user. In another embodiment, the trading server transfers as part of the communication 110, the requested reward mileage to be redeemed. The reward server computer 10 decreases the users reward account 52 by the requested number of reward points. The term point is used to reference any earned value that has a cash equivalent or negotiable worth as in “frequent flyer” point or mile. The reward server computer 10 conveys consideration to the trading server computer 20 where the consideration corresponds to the number of reward points decreased in the user's account 52 on the reward server 10. For example, the consideration may be in the form of a monetary credit to an account that exists between the trading server and the reward server, that gets paid at the end of a predefined billing cycle (i.e. every month). The trading server computer 20 increases the reward exchange account 54 associated with the user by the received number of points. The trading server computer 20 in turn, receives the consideration from the reward server computer 10.

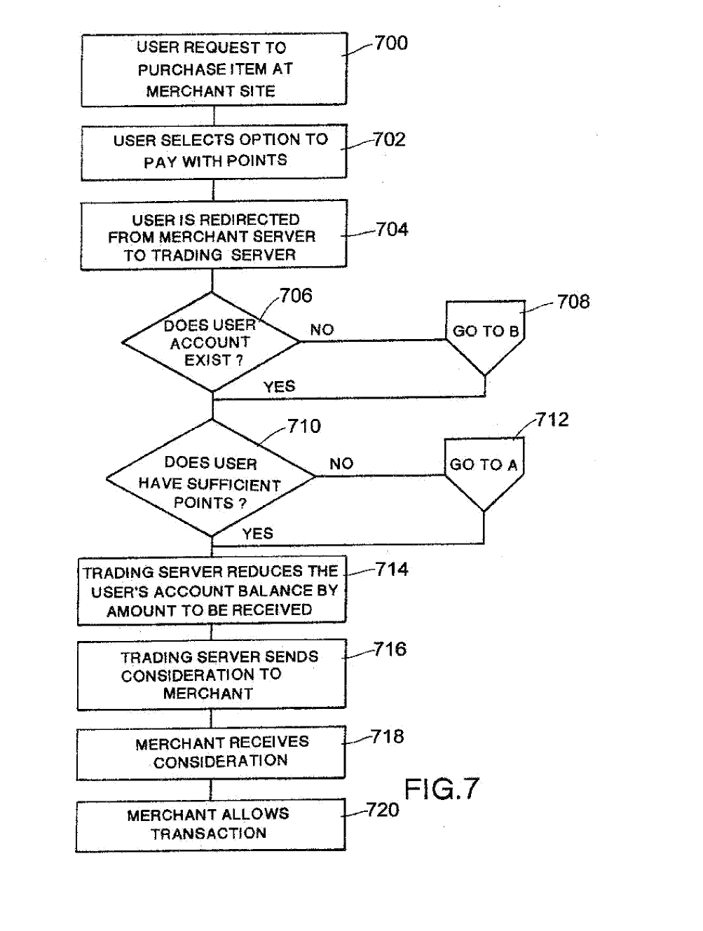

In the second part of the transaction (see FIG. 7), the user from a user computer 40 may make a request 150 to purchase an item from an associated merchant computer 30. In the preferred embodiment, the merchant computer system will be a networked computer system accessible via the Internet. The user would visit the site by selecting on a link from the trading server's web site or by entering the name or address of the destination site. The user may identify one or many items to be acquired from one or several merchants 30. The trading server computer 20 would confirm that the user has sufficient points to purchase the selected item by checking the user's reward exchange account 54. The trading server computer 20 would request the merchant computer to deliver the item to the user. The user delivery information may be retrieved from the trading server computer 20 or may be supplied in some other manner. The trading server computer 20 would decrease the user exchange account 54 by the number of points corresponding to the purchased item. The trading server computer 20 conveys consideration to the merchant computer 30 equivalent to the cost of the item by means well known in the art of electronic commerce (eg. by a preexisting account, credit card, etc.) In the alternative, the consideration may be a direct transfer of points to an account associated with the merchant.

Policies and profiles may be established to automatically contact each of the reward servers according to a user redemption profile (see FIG. 5) to transact the required payment for an item selected by a user. This profile may indicate the order of redemption and method of providing funds sufficient to cover the purchase after redeemable points are exhausted. For example, if a user has a preferred air carrier where the user would like to retain mileage in that reward system, the user may specify a priority of use indicating the reward resources that should be exhausted prior to accessing the most desirable rewards. Following the selection of an item to be acquired, the server may contact all of the reward resources according to this profile to selectively redeem each as required to meet the purchase price. The process may be performed in real time or as a background process where the user may select how the transaction should proceed. If the user exhausts lower personal worth resources from the reward servers, the system may be required to contact the user before the transaction is allowed to proceed to redeem points. A classification system may also be used to indicate rewards of similar worth. If for instance, a frequent flyer program supports multiple classifications of miles that may be redeemed differently, the user may optionally define how those resources should be managed during redemption. The redemption process would then honor those rules elected by the user to select from several different reward programs instead of redeeming rewards strictly on a value required from the first reward program contacted.

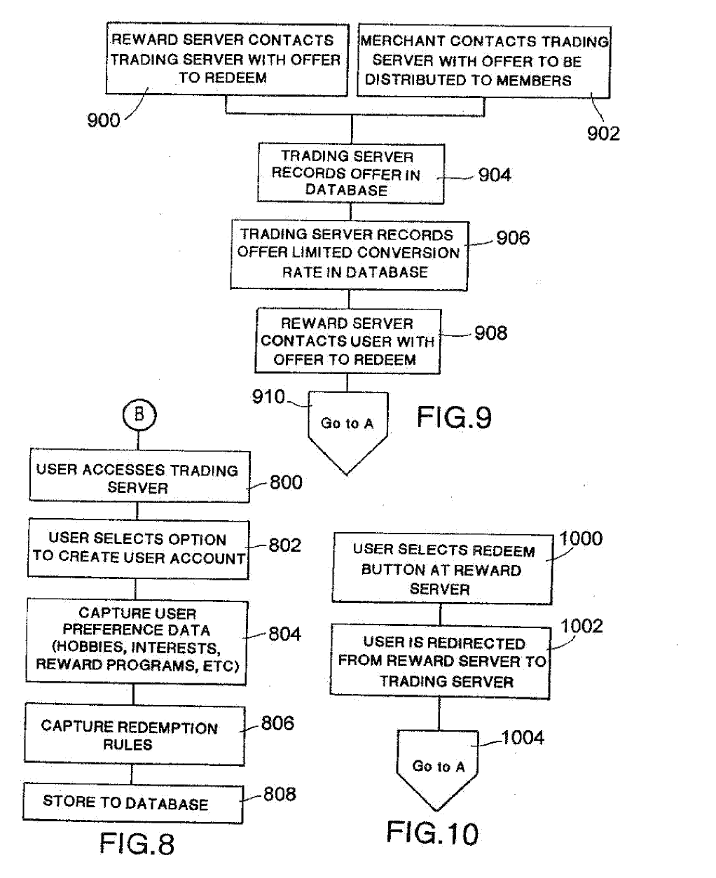

FIG. 8 describes the process steps involved in enrolling a user to utilize the trader server. The data entered by the user may be used in determining whether a user allows unsolicited offers to be presented from the trading server. The user's preferences for manufactured goods services, products, travel destinations, hobbies, interests or any other user entered criteria may be stored in the database for subsequent use by the system. The trading server has the ability to receive offers from reward servers or merchants which may then be directed to users based on the database profile information provided by the user (see FIG. 9).

The trading server may also be contacted in response to a button or hyperlink located on a web page accessible by the user from the airline reward server. In a similar manner, hyperlinks or calling routines may allow a user to access a reservations system or merchant from the trading server. The link would direct the user to partner or associated air carriers where the points in a user exchange account on the trading server 20 may be used to acquire reduced fare flights.

The system used to implement the aforementioned method will now be disclosed with respect to FIG. 5. The system is comprised of a trading server computer connected to a network of computers where a user interface is established whereby a user from a user computer may access the server to request the transaction to contact a reward server computer system. In the preferred embodiment, the server has memory means for storing the user account information, user profiles and rules specified by the user, system, or merchant. The trading server also has communications means to allow users to access the server and to allow the trading server to contact reward servers and processing means to interpret the rules and coordinate the contact to the respective reward servers. The processing means is adapted to allow the user to request and exchange consideration for rewards from reward servers. The processing means additionally is adapted to coordinate the exchange of consideration and increase or decrease the user exchange accounts stored in memory in response to actions performed by the user computer, reward server and merchants.

In the preferred embodiment, the memory means comprises a database structure that is used to record the transactions associated with the previously described method. Records indicating the changes and current value of user exchange accounts are updated according to the request processed by the processor.

In response to a request for redemption, the trading server looks up the contact properties of the reward server to be contacted. The user information is submitted to the reward server to display the available points that may be redeemed. In another embodiment, the request additionally contains a value to be redeemed. The processor establishes a communication link with the reward server and a transaction request is sent to the processor of the reward server. The processor of the reward server may perform actions that may allow or refuse the requested action. In another embodiment, the trading server processor may be granted direct authorization to modify the user's records in the reward server database without analysis by the processor of the reward server. A conversion rate may be applied to the transaction such that the reward server reduces the available rewards in the user's account. The reward server then transfers consideration to the trading server that corresponds to the value reduced in the reward system. In response to the receipt of the transfer or approval of the transfer, the trading server increments the user account balance to reflect the received consideration and the connection to the reward server is dropped. A transaction log may be used to record each of the transactions in case a reconciliation process is required at a later time. The increase in the user's exchange account may then be stored until a user finds an item to be purchased.

The user selects the desired object from the merchants by indicating the type of product or service to be procured. In one embodiment, the trading server contacts the merchant server to return to the user a list of products that match the user's search criteria or if the user had specified in detail what was desired, the product may be directly acquired from a merchant. A communication link is established between the trading server and the merchant computer or designee for e-commerce. Direct acquisition may be enacted by contacting the merchant computer and supplying the user indicia, the product indicia, and the redemption value sufficient to secure the transaction. In response to the transaction request, the merchant computer will receive the consideration supplied and contract for the delivery of the product. In another embodiment, the consideration required for the item selected is sent to the trading server where based on the available points in the user's exchange account the trading server will determine whether the consideration is available. An authorization process may be incorporated at this point to request authorization from the user or in a more simplified process, the consideration will be transferred to the merchant computer and the user's exchange account will be reduced. The merchant computer will receive the consideration and will effectuate a delivery transaction to be issued.

The goods may also be placed under direct control of a distribution arm of the trading service so that the user places the order with the trading service directly and the merchants are not directly involved with the sale of the goods.

Thus, the present invention provides a liability management system for issuers of reward points, which allows them to take points off the books and eliminate them, if desired, at a discount rate. This system enables the sale or repurchase of points with a trading strategy in which points need not expire.

The present system may be implemented by means of a smart card wherein frequent use points may be accumulated on the user's card every time the card is used for associated application. For example, if a user uses his smart card to pay for a hotel that normally gives reward points, those reward points may be stored on the smart card. Likewise, when the card is used for the purchase of an airline ticket, the points would be added to the smart card. The user may then redeem the accumulated reward points by inserting the card into a vender associated with a computer connected to the Internet. The trading process proceeds as described above, except that the points are obtained directly from the smart rather than a reward server.

The user may have a credit card, debit card, or stored value card that is linked to their points account in such a way as to permit them to pay for purchases with a merchant by using the card, wherein the merchant uses the existing credit card payment infrastructure as if payment were being made/authorized by a bank linked to the credit card or debit card account, but in fact the card is linked to the user's points account. In this manner, the user and merchant can use the points account to pay for purchases in a seamless manner whereby points are used for consideration rather than or as a supplement to cash and traditional credit.

Other aspects of this invention will now be disclosed that will enhance the reader's understanding of the application of this invention.

The user can purchase points from the system, borrow points from the system, etc., and basically treat the points as cash consideration for purposes of such transactions.

The system can prioritize the order of points being traded based on a predetermined set of rules such as in higher value points being issued before those with a lower value.

Merchandisers also benefit from the use of this system where another marketing channel is afforded for products that are often purchased by frequent travelers with high disposable income. Products and services encompassing jewelry, flowers, limousine transport, timeshare rental may be exchangeable for points stored in this system. Items purchased through the system may also be paid for by a combination of points and currency which might be the case when a user does not have enough accrued points to meet the purchase consideration of an item selected.

It is anticipated that high quality limited access products may benefit from the distribution methods afforded by this system. For example, companies like DeBeers and Chanel may take advantage of this distribution means without impacting the level of quality or excellence associated with their products.

Manufacturers can discount or liquidate goods for points in a manner that doesn't negatively affect the perceived value of the goods (i.e. not in direct competition with the mainstream sales). That is, the manufacturer can place overstocked, end of run type goods and the like, place them in the chain of distribution for exchange with points, and not be in direct competition with cash sales of its mainstream products.

Resort destinations that are managed by property management companies such as RCI may be integrated into this system where instead of trading accommodations with only those having similar property, it is now possible that the rental of the property may be achieved by conversion for points.

Offers may be distributed to users of this system where substantial rebates or reduced rates are described in the offer. Time sensitive product offerings can also be accommodated in the system where the value of the product is decreased according to a life span of the product. Time sensitive product offerings such as food products or concert tickets can have an associated diminishing or escalating value based on the length of the offer.

Using this system it is now possible to coordinate the products of several different providers into one package. A user of this system may therefore select an airline, hotel, car rental and Broadway show tickets in New York, individually or in a prepared package from one location by trading points where the package may not have existed before where the trading system coordinates all aspect of the transaction and reduces the user's exchange rewards in a corresponding manner.

Other purchasing leverage not specifically addressed previously may also be acquired by combining the power of a pool of high profile users of this system where these users may be allocated access to products or services not generally distributed to the remainder of the system users. Points collected in the system by these users may afford them access to limited distribution channels where higher discount levels or premium luxury products may be acquired. Direct access to cartel products such as diamonds, duty free items and other restricted access product or service offerings are also accommodated through the coordination of the trading server with these specialized service and product providers. For example, a preferred client distribution channel such as found in a European market for luxury goods would be made available to users of this system where the prices for the objects in this preferred channel may be significantly lower than retail for objects that are typically reserved for limited distribution at premium prices. The trading server may additionally have exclusive rights to allocate access to certain premium products, services, events, travel destinations or accommodations in accordance with any right or grant permitting such allocation to any user of the system. A distribution channel may make available exclusive products for all or a limited amount of the members of the system where the trading server system controls access to the offer. Parameters associated with the available quantity, duration, exchange rates, etc may be input into the system to be used in the allocation algorithm to restrict the offer. Upon user access, the trading server would, in these cases, modify the premiums offered to reflect the immediately attainable items for the current user and may additionally display or provide access to premiums that may be acquired through payment by other means (i.e. cash, charge, debit) to make up the difference between the user's available points and the points required to accept the offer.

In another embodiment of this invention, airlines seeking to provide higher levels of personalized service for their business travelers will provide access to the Internet or access to in-flight services such as video games, for a fee or in place of granting mileage rewards on transcontinental or transatlantic flights. Access to video games may be afforded to the traveler where the availability of different games depends on the number of reward points traded in by the traveler. The rewards may be converted using the trading server of this invention, where the user may opt to forego collecting mileage in return for accessing on-board entertainment provided in a standalone mode or in a linked mode. For example, users may select to play video games, access the Internet or utilize Email via a seatback or tray table mounted interface and controller. The user may optionally connect a laptop computer to an interface port of the aircraft using an Ethernet, parallel, USB connection or proprietary connector provided by the air carrier. In the preferred embodiment, the user would select the connection speed and type for communications based on whether in-flight or external services were to be accessed. Other types of business services may additionally be used and accounted for, such as using network printers or fax equipment. RF, satellite or microwave based communications may be used for real time communications where sufficient geographical coverage is provided.

The interface would allow a user to login using the frequent flyer account information or preferably, the trading server account login id and password, where the user may use points awarded from another air carrier or point server to “pay” for the services accessed. The account balance from the trading server may be transferred to the local controller prior to takeoff for each user that logs in to the trading server. Once the plane has departed, depending on the linking or access capability afforded by the air carrier or service provider, the user's account may be modified in real time or upon reconnection following landing, based on services selected by the traveler. If a real time link is supported, the user's exchange account may be periodically debited according to the services selected and duration of use.

In another aspect of the invention, an electronic bartering system is implemented, wherein product manufacturers, producers, distributors, etc. can provide surplus or overstocked goods for liquidation into the chain of supply of the system and exchange then for points as described herein. This provides an inventory management and liquidation system for these manufacturers and sellers.

In addition, the value of the reward points may fluctuate as a function of the company's performance, which may be measured by reference to the price of its stock, revenue, earnings, or some other parameter that is agreed to that reflects the relative performance of the company. In this manner, companies that perform well would provide an additional incentive to a user for using their frequent use program rather than a competitor's program. For example, all other parameters being the same, a user would likely choose the Acme credit card company over the Beta credit card company when the user determines that the Acme company performance results in a 10% increase in the number of points otherwise earned by using its credit card. The value may also fluctuate as a function of the number of points outstanding or the desirability of the issuer to reduce its liability or make it more robust.

1-37. (canceled)

38. A method of operating a loyalty program in association with a television broadcasting entity comprising:
a. providing first and second television content;
b. providing first and second reward content;
c. generating a first television broadcast signal comprised of said first reward content and said first television content;
d. generating a second television broadcast signal comprised of said second reward content and said second television content;
e. broadcasting over a broadcast communications medium said first and second television broadcast signals to a plurality of viewers;
f. at least one of said plurality of viewers receiving said first and second television broadcast signals via a receiving device operative with the broadcast communications medium;
g. outputting said first reward content obtained from said first television broadcast signal to said viewer via said receiving device;
h. outputting said second reward content obtained from said second television broadcast signal to said viewer via said receiving device;
i. said viewer providing a reward response based on said first reward content and said second reward content; and
j. crediting, in accordance with the reward response from the viewer, reward points to a reward point account stored on behalf of said viewer at a reward server computer.

39. The method of claim 38 wherein the reward response comprises two separate responses.

40. The method of claim 38 wherein said first reward content comprises a reference to said second television content.

41. The method of claim 38 wherein said first television content is of a first type, and said second television content is of a second type that is substantially different than said first type.

42. The method of claim 38 wherein at least either of said first and second reward content is provided to said viewer by scrolling said reward content so that part of said reward content is visible at a given time and part of said reward content is not visible at said given time, whereby said visible reward content will vary over a certain time period.

43. The method of claim 38 wherein at least either of said first and second reward content is provided to said viewer via a pop-up window.

44. The method of claim 38 wherein said viewer providing a reward response comprises:
(i) the viewer presenting a loyalty token to a merchant, the loyalty token linked to the reward point account;
(ii) the viewer providing the reward response to the merchant;
(iii) the merchant communicating with said reward server to provide a reward request to said reward server, said reward request comprising an instruction to add reward points to the reward point account associated with the viewer.

45. A method of broadcasting reward-based television programming comprising:
a. broadcasting, over a broadcast communications medium to a plurality of viewers:
i. a first television broadcast signal comprised of first reward content and first television content, and
ii. a second television broadcast signal comprised of second reward content and second television content; and
b. crediting, in accordance with a reward response provided by a viewer, reward points to a reward point account stored on behalf of said viewer at a reward server computer, said reward response based on said first reward content and said second reward content.

46. The method of claim 45 wherein the reward response comprises two separate responses.

47. The method of claim 45 wherein said first reward content comprises a reference to said second television content.

48. The method of claim 45 wherein said first television content is of a first type, and said second television content is of a second type that is substantially different than said first type.

49. The method of claim 45 wherein at least either of said first and second reward content is provided to said viewer by scrolling said reward content so that part of said reward content is visible at a given time and part of said reward content is not visible at said given time, whereby said visible reward content will vary over a certain time period.

50. The method of claim 45 wherein at least either of said first and second reward content is provided to said viewer via a pop-up window.

51. The method of claim 45 wherein the reward response is provided by a viewer by:
(i) the viewer presenting a loyalty token to a merchant, the loyalty token linked to the reward point account;
(ii) the viewer providing the reward response to the merchant;
(iii) the merchant communicating with said reward server to provide a reward request to said reward server, said reward request comprising an instruction to add reward points to the reward point account associated with the viewer.

52. A reward-based television programming broadcast system comprising:
a. broadcast equipment adapted to broadcast, over a broadcast communications medium to a plurality of viewers:
i. a first television broadcast signal comprised of first reward content and first television content, and
ii. a second television broadcast signal comprised of second reward content and second television content; and
b. a computer system adapted to credit, in accordance with a reward response provided by a viewer, reward points to a reward point account stored on behalf of said viewer at a reward server computer, said reward response based on said first reward content and said second reward content.

53. The system of claim 52 wherein said first reward content comprises a reference to said second television content.

54. The system of claim 52 wherein said first television content is of a first type, and said second television content is of a second type that is substantially different than said first type.

55. The system of claim 52 wherein at least either of said first and second reward content is provided to said viewer by scrolling said reward content so that part of said reward content is visible at a given time and part of said reward content is not visible at said given time, whereby said visible reward content will vary over a certain time period.

56. The system of claim 52 wherein at least either of said first and second reward content is provided to said viewer via a pop-up window.

57. The system of claim 52 wherein the viewer provides a reward response by:
(i) the viewer presenting a loyalty token to a merchant, the loyalty token linked to the reward point account;
(ii) the viewer providing the reward response to the merchant;
(iii) the merchant communicating with said reward server to provide a reward request to said reward server, said reward request comprising an instruction to add reward points to the reward point account associated with the viewer.
